(19) United States
(12) Patent Application Publication
(10) Pub. No.: US 2026/0313354 A1
(43) Pub. Date: Oct. 8, 2026

(54) Wireless Communications Device and Methods for Handling Communications with Two or More Networks

(71) Applicant: Telefonaktiebolaget LM Ericsson (publ), Stockholm (SE)

(72) Inventors: Maomao Chen Larsson, Lund (SE); Icaro Leonardo Da Silva, Solna (SE); Alessio Terzani, Stockholm (SE); Tomas Frankkila, Luleå (SE); Tahmineh Torabian Esfahani, Sollentuna (SE)

(21) Appl. No.: 19/476,756

(22) PCT Filed: Apr. 21, 2023
(86) PCT No.: PCT/EP2023/060493

§ 371 Date: Oct. 20, 2025

(51) Int. Cl. H04W 8/20; H04W 60/02; H04W 76/27; H04W 88/06

(52) U.S. Cl. CPC H04W 8/20; H04W 60/02; H04W 76/27; H04W 88/06

(57) ABSTRACT

The wireless communications device registers (401) with a first wireless communications network associated with a first SIM by providing one or more first capabilities. Upon being connected to a first wireless communications network, the wireless communications device transmits (403) a first request to the first network node to disable a set of capabilities from the one or more first capabilities. The wireless communications device connects (404) to a second network node of a second wireless communications network associated with a second SIM, such that the wireless communications device is connected to the first network node with reduced capabilities without the set of capabilities, and the wireless communications device is connected to the second network node using the set of capabilities When the wireless communications device has disconnected from the second network node, the wireless communications device manages (405) a reenabling procedure of the capabilities by: triggering a second request to the first network node to reenable the set of capabilities based on whether or not a first a first condition for triggering the re-enablement is fulfilled, or not triggering the second request based on whether or not a second condition for not triggering the re-enablement is fulfilled.

### TECHNICAL FIELD

Embodiments herein relate to a with a wireless communications device and methods performed therein regarding wireless communication. Furthermore, a computer program product and a computer-readable storage medium are also provided herein. In particular, embodiments herein relate to handling communication with two or more networks, such as handling operation of a multi-Subscriber Identity Module (SIM) user equipment.

### BACKGROUND

In a typical wireless communications network, User Equipment (UE), also known as wireless communication devices, mobile stations, stations (STA) and/or wireless devices, communicate via a Radio Access Network (RAN) with one or more core networks (CN). The RAN covers a geographical area which is divided into service areas or cell areas, with each service area or cell area being served by radio network node such as an access node, e.g., a Wi-Fi access point or a radio base station (RBS), which in some networks may also be called, for example, a NodeB, a gNodeB, or an eNodeB. The service area or cell area is a geographical area where radio coverage is provided by the radio network node. The radio network node operates on radio frequencies to communicate over an air interface with the UEs within range of the radio network node. The radio network node communicates over a downlink (DL) to the UE, and the UE communicates over an uplink (UL) to the radio network node.

A Universal Mobile Telecommunications System (UMTS) is a third generation telecommunication network, which evolved from the second generation (2G) Global System for Mobile Communications (GSM). The UMTS terrestrial radio access network (UTRAN) is essentially a RAN using wideband code division multiple access (WCDMA) and/or High-Speed Packet Access (HSPA) for communication with user equipment. In a forum known as the Third Generation Partnership Project (3GPP), telecommunications suppliers propose and agree upon standards for present and future generation networks and UTRAN specifically, and investigate enhanced data rate and radio capacity. In some RANs, e.g., as in UMTS, several radio network nodes may be connected, e.g., by landlines or microwave, to a controller node, such as a radio network controller (RNC) or a base station controller (BSC), which supervises and coordinates various activities of the plural radio network nodes connected thereto. The RNCs are typically connected to one or more core networks.

Specifications for the Evolved Packet System (EPS) have been completed within the 3GPP and this work continues in the coming 3GPP releases, such as 6G networks and development of 5G such as New Radio (NR). The EPS comprises the Evolved Universal Terrestrial Radio Access Network (E-UTRAN), also known as the Long-Term Evolution (LTE) radio access network, and the Evolved Packet Core (EPC), also known as System Architecture Evolution (SAE) core network. E-UTRAN/LTE is a 3GPP radio access technology wherein the radio network nodes are directly connected to the EPC core network. As such, the Radio Access Network (RAN) of an EPS has an essentially “flat” architecture comprising radio network nodes connected directly to one or more core networks.

With the emerging 5G technologies, such as new radio (NR), the use of very many transmit-and receive-antenna elements is of great interest as it makes it possible to utilize beamforming, such as transmit-side and receive-side beamforming. Transmit-side beamforming means that the transmitter can amplify the transmitted signals in a selected direction or directions, while suppressing the transmitted signals in other directions. Similarly, on the receive-side, a receiver can amplify signals from a selected direction or directions, while suppressing unwanted signals from other directions.

Next generation systems are expected to support a wide range of use cases with varying requirements ranging from fully mobile devices to stationary internet of things (IoT) or fixed wireless broadband devices. The traffic pattern associated with many use cases may be expected to consist of short or long bursts of data traffic with varying length of waiting period in between, here called inactive state. In NR, both license assisted access and standalone unlicensed operation are to be supported. Hence, the procedure of Physical Random Access Channel (PRACH) transmission and/or Scheduling Request (SR) transmission in unlicensed spectrum may be investigated in 3GPP.

Multiple Subscriber Identity Module (SIM), or “Multi-SIM” or “Multi-USIM,” devices are devices which enable use of multiple subscriptions in one device using more than one Universal Subscriber Identity Module (SIM or USIM). Multi-SIM UE's support concurrent registration to more than one network simultaneously and, e.g., if a UE has two different radios implemented, such as both dual receive (Rx) and dual transmit (Tx) capability, it would be possible for the UE to behave as two separate UEs and communicate with two networks at the same time. There are also dual or multi-SIM capable UEs that only have one single radio front-end and baseband processing.

A single UE, which is capable of having two or more subscription credentials, may thus act as two UEs within one device/hardware entity. The ability of a UE to support multiple USIMs (MUSIM) has become a mainstream feature. For example, a user may have a work SIM, a private SIM, and other SIMs for other purposes, which may be used in one or more UEs. As another example, mobile devices such as a smartphone, a smartwatch and other wearables, need to have multi-SIM capability to be able to connect to the same mobile number. Multi-SIM capability for voice calls means that a user may be reached at the same mobile number via these devices without connecting via the smartphone.

MUSIM devices, e.g., UEs with more than one receiver (Rx) and/or transmitter (Tx), may simultaneously connect to more than one network such as a Public Land Mobile Network (PLMN). Factors such as, e.g., different possible network configurations and a changing demand for diverse types of operations, e.g., multi-carrier, may affect the complexity of such frameworks. For example, for UEs with dual Rx and dual Tx radios, certain services on one network may require both radios to satisfy quality of service (QOS) requirements, leaving no resources for another network.

Some legacy Multi-SIM UEs support a Dual SIM Dual Standby (DSDS) type of operation. DSDS operation means that only one of the USIMs can be actively connected to its PLMN with an RRC_Connected mode to receive data, while the other USIM is in an RRC_Idle/RRC_inactive mode to be standby for a request to be actively connected to the PLMN. This is based on the UE architecture as Single-Rx or Dual-Rx, together with a Single-Tx, which is taken as a legacy UE architecture, supported up to 3GPP Rel- 17 .

It remains a challenge to manage and support UEs that can have two or more simultaneous subscriptions with more than one network. For example, even though mobile terminals with Multi-SIM functionality exist, there is no specific standardized support for Multi-USIM devices such that various UE implementations and behaviors exist. For example, it may not be possible for a UE to receive and/or send data using one subscription, while having an ongoing service with another subscription.

The capability of only supporting a Single-Tx limits the Multi-SIM operation to be active in connected mode (sending and/or receiving data) with one USIM and the other USIM in an idle mode, as there is no possibility for UL feedback to the network side for the other USIM to become active if the single Tx is occupied by UL transmissions for the first USIM which is in an active mode.

For UEs with dual Tx and dual Rx using static UE assistance information, available resources may be underutilized. Furthermore, service quality at a network may need to be controlled when UE capabilities are changed such as downgraded or restored.

### SUMMARY

An object herein is to provide improved handling of operation of a multi-SIM wireless communications device, such as a multi-SIM UE. There is today ongoing work in 3GPP which is based on an architecture of the wireless communications device with Dual Rx and Dual-Tx, that is two independent receivers and two independent transmitters. For example, work is done to provide enhancements for MUSIM procedures to operate in RRC_CONNECTED state simultaneously in a first network and in a second network.

Hardware capabilities of a MUSIM wireless communications device are shared by the SIMS, and to use the hardware efficiently and economically, the related capabilities need to be dynamically split between the two SIMs. This may lead to a temporary hardware conflict for the wireless communications device, which may require the wireless communications device to release some resources, e.g. Secondary Cells SCell or Secondary Cell Group (SCG), from one SIM. For example, when the first SIM of the wireless communications device is in RRC connected state in a first network while the second SIM of the wireless communications device is in RRC Idle or RRC Inactive in a second network, the two receivers and transmitters will be occupied by the first SIM for the communication in first network. In the following a receiver and a corresponding transmitter may also be referred to as a Radio Frequency (RF) chain. Once the second SIM enters into RRC connected state, one of the RF chains needs to be switched to the second SIM. In this case, if the first network is not aware of the reduced capability change in RF chain, there may be data loss due to demodulation failure and wasting radio resources in first network. To avoid this, assistance from the wireless communications device to the first network on temporary capability restrictions may be beneficial.

Specifically, the wireless communications device may be capable of disabling some of the capabilities for communications with the wireless communications network. Disabling some of the capabilities allows the wireless communications device communicating with at least a second wireless communications network while retaining communications with a first wireless communications network. Thus, the wireless communications device is enabled to be simultaneously connected, e.g., in RRC_CONNECTED mode, with multiple wireless communications networks to adapt the configuration of the available radio resources to the current needs and/or situation of the wireless communications device. When the capabilities of the wireless communications device change, e.g., they are downgraded or restored, the wireless communications device may trigger a request to disable capabilities to a network which has control over the service quality level that has been negotiated for ongoing services. Furthermore, when the services for the wireless communications device are restored after a temporary downgrade, the network will know whether there are sufficient radio and/or network resources to restore the services for the wireless communications device.

More specifically, embodiments of the present disclosure provide a way for a wireless communications device to trigger an indication to a wireless communications network to reenable certain capabilities for communications with the first wireless communications network, e.g. when communications with the at least second wireless communications network has ended. However, the indication to the wireless communications network to reenable certain capabilities for communication increases signaling, and consequently a power consumption of the wireless communications device. Furthermore, network resources may not be fully utilized if the wireless communications device always triggers the indication to reenable the capabilities for communication when communications with the at least second wireless communications network has ended.

Embodiments of the present disclosure describe when and/or under what condition(s) the UE will or will not trigger the procedure to indicate the preference of reenabling the UE capability from both USIM to one USIM for a MUSIM wireless communications device.

According to a first aspect of the present disclosure, the object is achieved by providing a method, performed by a wireless communications device comprising at least two SIMs and at least two independent receiver chains and at least two independent transmitter chains, for handling communication with two or more networks. An RF chain, such as a receiver chain or a transmitter chain may be a cascade of electronic components and sub-units which may include amplifiers, filters, mixers, attenuators and detectors.

The wireless communications device registers with a first wireless communications network associated with a first SIM of the wireless communications device, by providing, to a first network node associated with the first wireless communications network, one or more first capabilities of the wireless communications device associated with the at least two independent receiver chains and the at least two independent transmitter chains.

The wireless communications device registers with a second wireless communications network associated with a second SIM of the wireless communications device, by providing, to a second network node associated with the second wireless communications network, one or more second capabilities of the wireless communications device associated with the at least two independent receiver chains and the at least two independent transmitter chains.

Upon being connected to the first wireless communications network and using the one or more first capabilities for a service, the wireless communications device transmits a first request to the first network node to disable a set of capabilities from the one or more first capabilities provided to the first network node.

The wireless communications device connects to the second network node and using the set of capabilities for a service in the second wireless communications network once the first network node accepts the first request and disables the set of capabilities, such that the wireless communications device is connected to the first network node with reduced capabilities without the set of capabilities, and the wireless communications device is connected to the second network node using the set of capabilities.

When the wireless communications device has disconnected from the second network node and continues to be connected to the first network node using the reduced capabilities, the wireless communications device manages a reenabling procedure of the capabilities by: triggering a second request to the first network node to reenable the set of capabilities for communication with the first network node based on whether or not a first a first condition for triggering the re-enablement is fulfilled, or
not triggering the second request to the first network node to reenable the set of capabilities for communication with the first network node based on whether or not a second condition for not triggering the re-enablement is fulfilled.

According to a second aspect of the present disclosure, the object is achieved by providing the wireless communications device, for communication with two or more wireless communications networks, wherein the wireless communications device is configured to perform the method according to the first aspect above.

It is furthermore provided herein a computer program comprising instructions, which, when executed on at least one processor, cause the at least one processor to carry out the methods herein, as performed by the wireless communications device.

It is additionally provided herein a computer-readable storage medium, having stored thereon a computer program comprising instructions which, when executed on at least one processor, cause the at least one processor to carry out the methods herein, as performed by the wireless communications device.

Embodiments herein enable support for a dual connectivity of the wireless communications device in more than one wireless communications network. The wireless communications device may stay in RRC_CONNECTED mode simultaneously on two or more networks, for Multi-SIM purposes. Furthermore, capability coordination of the wireless communications device with a wireless communications network is enabled, by switching partial capability, e.g., frequencies, and/or Tx or Rx chains, from or to the wireless communications network. Thus, embodiments herein enable communication of multi-SIM UEs in an efficient manner in a wireless communications network, and thereby improve the overall performance of the wireless communications network and/or improve user experience.

More specifically, embodiments herein provide implementation solutions for the wireless communications device to decide under what conditions to trigger the procedure of reenabling the capability from shared capability on both the first and second wireless communications networks to the first wireless communications network, and under what conditions not to trigger the procedure of reenabling the capability.

When the wireless communications device decides to trigger the procedure of reenabling the capability, it helps the wireless communications device prioritize the first wireless communications network such that network resources are more optimized based on the prioritization to support the user's needs.

Further, when the wireless communications device decides not to trigger the procedure of reenabling the capability, it provides the possibility to reduce the signaling, and consequently the power consumption of the wireless communications device.

### BRIEF DESCRIPTION OF THE DRAWINGS

Embodiments will now be described in more detail in relation to the enclosed drawings, in which:

FIG. 1A is a schematic overview depicting a wireless communications network in accordance with some embodiments of the present disclosure;

FIG. 1B is a combined signalling scheme and flowchart, showing communications between a wireless communications device and first and second network nodes, in accordance with some embodiments;

FIG. 2 is a schematic flowchart illustrating a method performed by a wireless communications device, in accordance with some reference methods;

FIG. 3 is a combined signalling scheme and flowchart, showing communications between a wireless communications device and first and second network nodes, in accordance with some reference methods;

FIG. 4 is a schematic flowchart illustrating a method performed by a wireless communications device, in accordance with some embodiments disclosed herein; FIG. 5 is a schematic flowchart illustrating a method performed by a wireless communications device, in accordance with some embodiments disclosed herein; FIGS. 6A and 6B are block diagrams depicting a wireless communications device in accordance with some embodiments;

FIG. 7 illustrates a telecommunication network connected via an intermediate network to a host computer, in accordance with some embodiments;

FIG. 8 illustrates a host computer communicating via a base station with a user equipment over a partially wireless connection, in accordance with some embodiments;

FIG. 9 is a flowchart illustrating methods implemented in a communication system including a host computer, a base station, and a user equipment, in accordance with some embodiments;

FIG. 10 is another flowchart illustrating methods implemented in a communication system including a host computer, a base station, and a user equipment, in accordance with some embodiments;

FIG. 11 is another flowchart illustrating methods implemented in a communication system including a host computer, a base station, and a user equipment, in accordance with some embodiments; and

FIG. 12 is another flowchart illustrating methods implemented in a communication system including a host computer, a base station, and a user equipment, in accordance with some embodiments.

### DETAILED DESCRIPTION

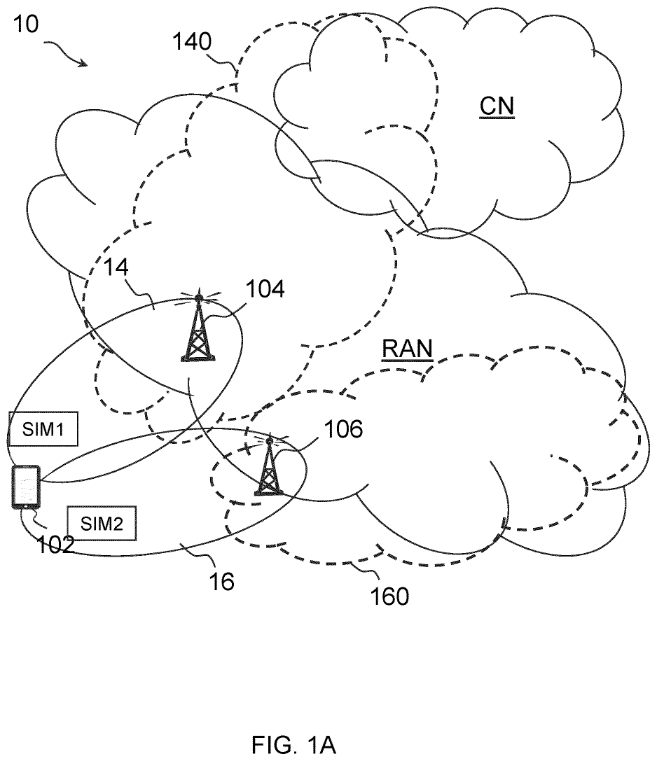

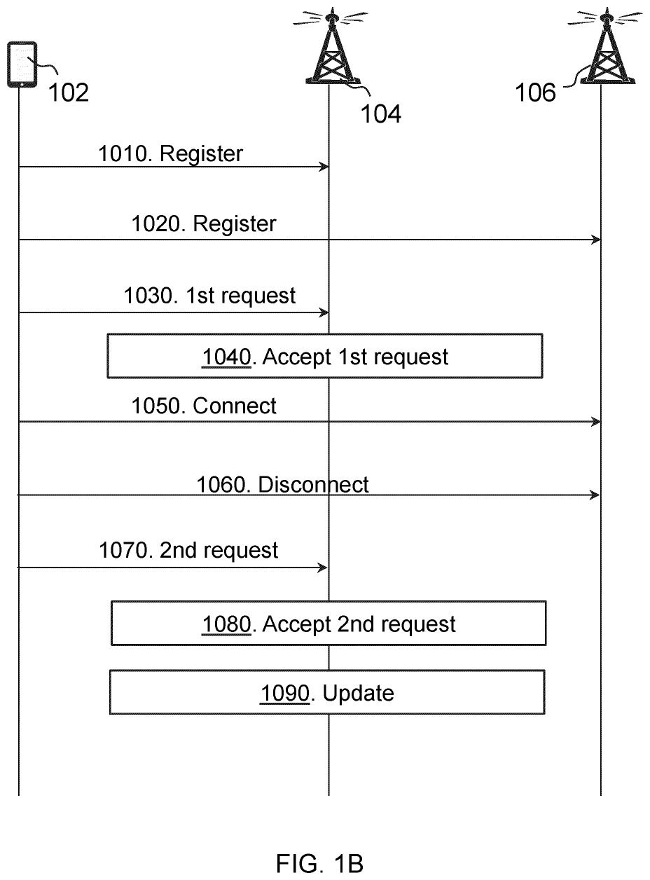

Embodiments herein relate to wireless communications networks in general. FIG. 1A is a schematic overview depicting a wireless communications network 10. The wireless communications network 10 comprises one or more RANs and one or more CNs. The wireless communications network 10 may use one or a number of different technologies. Embodiments herein relate to recent technology trends that are of particular interest in a New Radio (NR) context, however, embodiments are also applicable in further developments of existing wireless communications systems such as e.g. LTE or Wideband Code Division Multiple Access (WCDMA).

In the wireless communications network 10, a user equipment (UE) 102, such as a mobile station, a wireless device, a non-access point (non-AP) STA, a STA, and/or a wireless terminal, is communicating via e.g. one or more Access Networks (AN), e.g.

RAN, to one or more core networks (CN). It should be understood by the skilled in the art that “UE” is a non-limiting term which means any terminal, wireless communications terminal or device, user equipment, NB-IOT device, Machine Type Communication (MTC) device, Device to Device (D2D) terminal, or node, e.g. smart phone, laptop, mobile phone, sensor, relay, mobile tablets or even a small base station capable of communicating using radio communication with a radio network node within an area served by the radio network node.

The wireless communications network 10 comprises one or more first network nodes.

The wireless communications network 10 comprises a first network node 104, e.g., an access node, an access controller, a base station, e.g. a radio base station such as a gNodeB (gNB), an evolved Node B (eNB, eNode B), a NodeB, a base transceiver station, a radio remote unit, an Access Point Base Station, a base station router, a Wireless Local Area Network (WLAN) access point or an Access Point Station (AP STA), MME, AMF, a stand-alone access point, or any other network unit or node capable of communicating with a wireless device within a service area 14 served by the radio network node depending e.g., on a radio access technology and terminology used. The service area 14 may also be referred to as a beam or a beam group of a first radio access technology (RAT), such as 5G, LTE, Wi-Fi, or similar. The first network node 104 may be associated with and provide radio communication in a first wireless communications network 140, such as, e.g., a first Public Land Mobile Network (PLMN) or a first Non-Public Network (NPN). In some embodiments, the first wireless communications network 140 may be implemented as a combination of a PLMN and an NPN.

The wireless communications network 10 also comprises a second network node 106, e.g., an access node, an access controller, a base station, e.g. a radio base station such as a gNodeB (gNB), an evolved Node B (eNB, eNode B), a NodeB, a base transceiver station, a radio remote unit, an Access Point Base Station, a base station router, a Wireless Local Area Network (WLAN) access point or an Access Point Station (AP STA), MME, AMF, a stand-alone access point, or any other network unit or node capable of communicating with a wireless device within a service area 16 served by the radio network node depending e.g., on a radio access technology and terminology used. The service area 16 may also be referred to as a beam or a beam group of a first radio access technology (RAT), such as 5G, LTE, Wi-Fi, or similar. The second network node 106 may be associated with and provide radio communication in a second wireless communications network 160, such as, e.g., a second PLMN or a second NPN. In some embodiments, the second wireless communications network 160 may be implemented as a combination of a PLMN and an NPN.

Embodiments of the present disclosure relate to multi-SIM, or MUSIM, devices that enable users to be registered to multiple networks, such as PLMNs, NPNs, or a combination thereof. For instance, UEs equipped with dual radio capabilities may enable simultaneous connection to two wireless communications networks.

As shown in FIG. 1A, the UE 102 may thus be a multi-SIM UE and it may have a first SIM, shown as SIM1, and a second SIM, shown as SIM2, though it should be appreciated that the UE 102 may have more than two SIMs. In the illustrated embodiment, the first wireless communications network 140, such as the first PLMN or NPN, is associated with the first SIM of the UE 102, and the second wireless communications network 160, such as the second PLMN or NPN, is associated with the second SIM of the wireless communication device.

The UE 102 may be registered with both the first and second wireless communications networks 140, 160, which may be respective PLMNs, NPNs, a combination of PLMN(s) and NPN(s), or any other wireless communications networks that may be of the same or different types. As used herein, a PLMN is defined as a wireless communications network that provides a combination of wireless communication services offered by an operator. As used herein, an NPN is defined as a private network that is deployed for private use by an entity such as a government, company, or another entity. In some embodiments, when the UE 102 has multiple SIMs, the different SIMs are associated with different PLMNs or NPNs. In some embodiments, the UE 102 may have more than one SIM which is associated with the same network such as a PLMN and/or NPN, e.g., the UE 102 may have two SIMs from the same operator.

Some aspects of the present disclosure may be implemented in connection with the radio resource control (RRC) protocol.

In some embodiments, aspects of the present disclosure may be implemented in a cloud environment.

The UE 102 has more than one radio, such as, e.g., both dual receive (Rx) and dual transmit (Tx) capability. This means that there are at least two independent Rx receiver chains supported by the UE for DL data receptions and there are at least two independent Tx transmitter chains supported by the UE for UL data transmissions. The radios may support RRC Connected mode in a network, e.g., one of the first and second wireless communications networks 140, 160, without interrupting service of the other network, e.g., the other one of the first and second wireless communications networks 140, 160.

The number of Rx/Tx radio chains may play a role on how multi-SIM UEs are managed. Furthermore, different possible network configurations and a changing demand for diverse types of operations may affect the complexity of handling communications of multi-SIM UEs which may communicate with multiple wireless communications networks. For example, the UE may be capable of NR StandAlone (SA) with Carrier Aggregation (CA) or NR Dual Connectivity (DC) on at least one of the USIMs associated with at least one PLMN.

CA was standardized in 3GPP Rel-10 for 4G/LTE. CA may be used to enable higher throughput or improved robustness.

With 5G Rel-15, 3GPP introduced Dual Connectivity/Multi Connectivity. This gives a more flexible usage of multiple transceivers where the different transceivers may be used for:
Connecting to multiple cells, e.g., one cell for NR on one frequency band and another cell for NR on a different frequency band. This is similar to how CA/DC can be used in LTE.
Connect different RATs, e.g., use one NR cell and another LTE cell. This is different from how CA/DC can be used in LTE.

This may be used for, e.g.:
Improved coverage, e.g., one Tx/Rx is connected to one cell using a high frequency band and another cell using a low frequency band for wide-area coverage.
Higher throughput, using two connections instead of one.
Improved robustness, where data is received/transmitted in one cell and repeated in the other cell.
Load balancing, where different services use different cells to distribute the load over different cells when some cells become congested while resources are still available on another cell.
An operator can use both 4G/LTE and 5G/NR in small areas (indoor, hot spots) where the capacity needs to be boosted while still using 4G/LTE for general usage in the whole system. This allows for gradual deployment of 5G/NR.

When the UE 102 is registered with network A only, the UE 102 may provide its capability information to network A, which corresponds to a situation when the UE 102 is only using one of the SIMS. This means that it corresponds to a single-SIM UE and all capabilities that are available in the UE, e.g., frequencies, carrier combinations, features, processing, etc., are available for use with network A.

According to embodiments herein the UE 102 can communicate with two different wireless communications networks simultaneously. Thus, for example, when the UE 102 is registered with PLMN1 and PLMN2, or other types of wireless communications networks, at the same time, the UE 102 may, as in the case when the UE 102 is registered with one network only, provide full capabilities to network A and network B.

FIG. 1B is a combined flowchart and signalling scheme depicting some reference methods to indicate the preference of releasing the UE capability, e.g. by indicating temporary UE capability restrictions, from one USIM to both USIM, and reenabling the UE capability from both USIM to one USIM. These reference methods may be improved by embodiments herein.

Action 1010. The UE 102 registers to the first network node 104 associated with the first SIM. The UE 102 may register by providing, to the first network node 104, a first information comprising one or more first capabilities of the UE 102.

Action 1020. The UE 102 registers to the second network node 106 associated with the second SIM. The UE 102 may register by providing, to the second network node 106, a second information comprising one or more second capabilities of the UE 102.

Action 1030. The UE 102 sends a first request to the first network node 104 to disable a set of capabilities from the one or more first capabilities in the first information provided to the first network node 104.

Action 1040. The first network node 104 accepts the first request and disables the set of capabilities for communication with the UE 102.

Action 1050. The UE 102 may then connect to the second network node 106 using the set of capabilities.

Action 1060. The UE 102 may later disconnect from the second network node 106.

Action 1070. When the UE 102 disconnects from the second network node 106 and may continue to be connected to the first wireless communications network 140 using the reduced capabilities, the UE 102 may transmit a second request, to the first network node 104, to reenable the set of capabilities for communication with the first wireless communications network 140.

Action 1080. The first network node 104 may then accept the second request.

Action 1090. The first network node 104 may update and reenable the set of capabilities for communication with the UE 102 to thereby allow the UE 102 to revert to using at least a portion of the reenabled set of capabilities from the first information comprising the one or more first capabilities of the UE 102 to connect to the first wireless communications network 140.

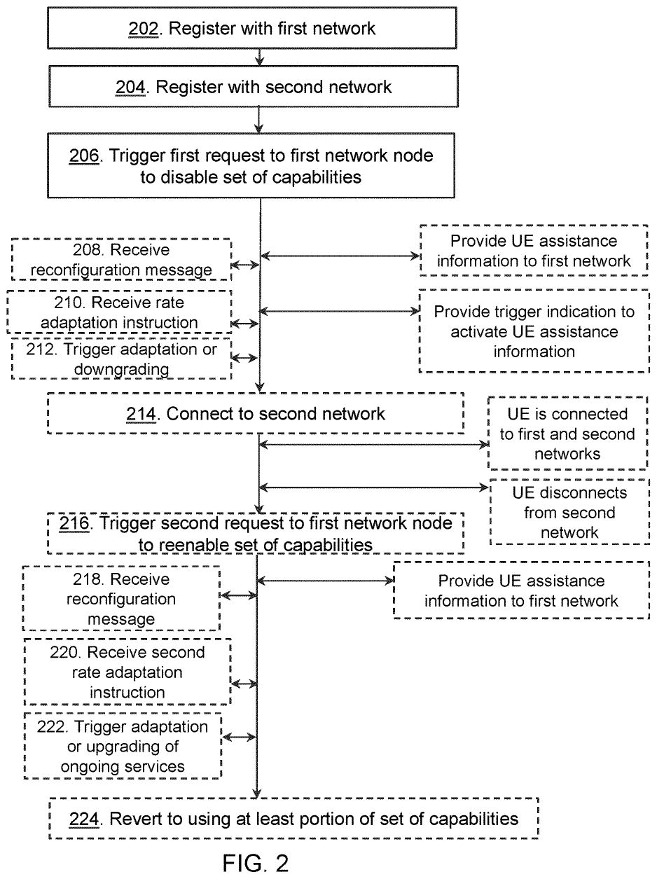

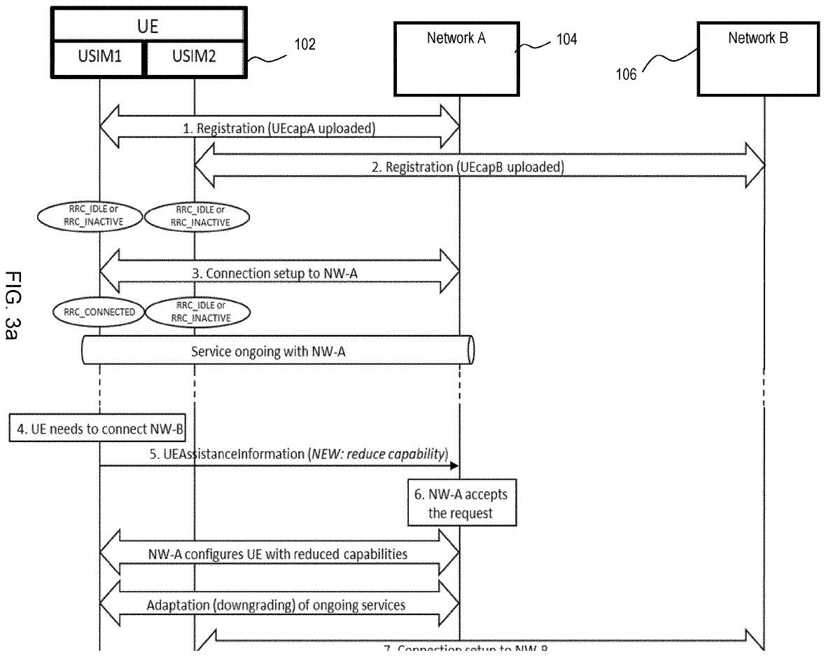

FIG. 2 illustrates an example of a reference method performed by a multi-SIM enabled UE, such as the UE 102, to indicate the preference of releasing the UE capability, e.g. by indicating temporary UE capability restrictions, from one USIM to both USIM, and reenabling the UE capability from both USIM to one USIM. The UE 102 has the first and second SIMs. However, the UE may have, e.g., three, four, five, six, or more than six SIMs.

Optional actions are shown using a dashed line. The acts of FIG. 2 may be performed in any suitable order.

Action 202. The UE 102 registers with the first wireless communications network 140 associated with the first SIM, e.g., first wireless communications network 140 of FIG. 1A. The UE 102 may register with the first wireless communications network 140, by providing, to the first network node, e.g., first network node 104, associated with the first wireless communications network 140, the first information comprising the one or more first capabilities of the UE 102. The one or more first capabilities of the UE 102 in the first information comprise UE capabilities relevant to the first wireless communications network 140. In some embodiments, the first information comprises information on full capabilities of the UE 102.

The first information, which may comprise information on full capabilities of the UE 102, may comprise information on one or more out of: a) a number of carriers supported by the UE; b) one or more carrier combinations supported by the UE; c) one or more processing capabilities of the UE; d) one or more features supported by the UE; e) a number of radio frontends that the UE has; f) a bandwidth supported by the UE; g) a buffer or memory size supported by the UE; h) a number of PDN connections or PDU connections supported by the UE; i) one or more carrier aggregation related capabilities of the UE; and j) one or more dual connectivity related capabilities of the UE. In some embodiments, registering with the first wireless communications network 140 comprises being configured by the first network node 104 based on the first information comprising the one or more first capabilities of the UE. The first network node 104 configures the UE 102 according to the one or more first capabilities of the UE 102 provided to the first network node 104.

Action 204. The UE 102 may register with the second wireless communications network associated with a second SIM, e.g., second wireless communications network 160 of FIG. 1A. The UE 102 register with the second wireless communications network, by providing, to the second network node, e.g., second network node 106, associated with the second wireless communications network, the second information comprising the one or more second capabilities of the UE 102. The one or more second capabilities of the UE 102 in the second information comprise UE capabilities relevant to the second wireless communications network. In some embodiments, the second information comprises information on full capabilities of the UE 102.

The second information, which may comprise information on full capabilities of the UE 102, may comprise information on one or more out of: a) a number of carriers supported by the UE; b) one or more carrier combinations supported by the UE; c) one or more processing capabilities of the UE; d) one or more features supported by the UE; e) a number of radio frontends that the UE has; f) a bandwidth supported by the UE; g) a buffer or memory size supported by the UE; h) a number of PDN connections or PDU connections supported by the UE; i) one or more carrier aggregation related capabilities of the UE; and j) one or more dual connectivity related capabilities of the UE.

The one or more first capabilities may be the same, partly the same, or different capabilities as to the one or more second capabilities.

In some embodiments, registering with the second network comprises being configured by the second network node 106 based on the second information comprising the one or more second capabilities of the UE 102. The second network node 106 configures the UE 102 according to the one or more second capabilities of the UE 102 provided to the second network node 106.

In some embodiments, thus, the UE 102 may be configured by a network node, such as one or both the first and second network nodes, or any other network nodes, to provide UE assistance information, and other related information, to the network node, due to the network node awareness that the UE 102 is a Multi-USIM UE.

The UE 102 may thus be simultaneously registered with the first and second wireless communications networks. In some embodiments, the first wireless communications network 140 and the second wireless communications network are different networks. In some embodiments, the first wireless communications network 140 and the second wireless communications network are the same network.

In some embodiments, the first wireless communications network 140 is NR, and the second wireless communications network is LTE or NR. In some embodiments, the first wireless communications network 140 is LTE or NR, and the second wireless communications network is NR.

Information e.g. about one or more out of the UE behavior, traffic pattern(s), and UE-assisted information (UAI), may be conveyed from the first wireless communications network 140 to the second wireless communications network, or vice versa. For example, the information may be included in a transparent container and passed from one network to another via CN. The wireless communications network which receives the information, upon the reception of such information, may make more informed decisions regarding preconfiguring and predicting.

The first wireless communications network 140 may be a first PLMN or a first NPN, and the second wireless communications network may be a second PLMN or a second NPN. In some embodiments, the first and second wireless communications networks may both be PLMNs or NPNs. In some embodiments, the first wireless communications network 140 is a PLMN and the second wireless communications network is an NPN. In some embodiments, the first wireless communications network 140 is an NPN and the second wireless communications network is an PLMN. In some embodiments, one or both the first and second wireless communications networks are a combination of a PLMN and an NPN.

As used herein, that the UE 102 is registered with a wireless communications network, such as with a PLMN or an NPN, means that the UE 102 receives and/or transmits signals with that wireless communications network when in a connected mode. The UE 102 may also be registered with the wireless communications network when in idle mode, in which case the UE 102 is at least ready to receive some signals (e.g., paging signals) from that wireless communications network.

After the UE 102 has been registered in the first and second wireless communications networks, and the respective relevant UE capabilities have been provided to the first and second wireless communications networks, the UE 102 may be disconnected from the first and second wireless communications networks.

At some point, the UE 102 may start a service in the first wireless communications network 140. Thus, the UE 102 becomes connected to the first wireless communications network 140 and may be disconnected from the second wireless communications network. The UE 102 may be in an RRC_CONNECTED mode in the first wireless communications network 140, while the UE 102 is in an RRC_IDLE mode, or state, or an RRC_INACTIVE mode or state in the second wireless communications network.

Action 206. The UE 102 triggers the first request to the first wireless communications network 140 to disable the set of capabilities. The first request may be triggered when the UE 102 needs to connect to the second wireless communications network. In some embodiments, upon being connected to the first wireless communications network 140 and using the one or more first capabilities for a service, the UE 102 triggers the first request to the first network node 104 to disable the set of capabilities from the one or more first capabilities e.g. in the first information provided to the first network node 104 or the one or more first capabilities configured by the first network. Thus, the UE 102 indicates to the first network node 104 that some of the one or more first capabilities, which may be the capabilities that the UE 102 previously provided to the first network node 104, be temporary disabled. For example, certain carrier frequencies may need to be disabled, to allow the UE 102 to connect to the second wireless communications network as well.

The set of capabilities that the UE 102 requests the first wireless communications network 140 to disable may be one or more capabilities from the first information provided to the first network node 104 by the UE 102. The first wireless communications network 140 may disable capabilities based on the requested set of capabilities it receives, such that the UE 102 communicates with the first network node 104 using reduced capabilities.

The first information may comprise one or more carrier frequencies, wherein the set of capabilities from the one or more first capabilities in the first information comprises at least one carrier frequency from the one or more carrier frequencies.

The first request may comprise a UE assistance information, such that the UE 102 provides the UE assistance information to the first network node 104.

The UE assistance information may comprise one or more of: an indication in an In-Device-Coexistence (IDC) assistance information; an indication in the IDC assistance information in combination with a MUSIM indication; and a MUSIM assistance information. In some embodiments, the MUSIM assistance information is separated from the IDC assistance information and the IDC assistance information is not modified due to MUSIM.

The first request to the first network node 104 may be provided in response to a change in at least one condition of the UE 102 in at least one of the first and second wireless communications networks, wherein the change in the at least one condition comprises a channel condition and/or a change of data demands. When a change in one or more conditions on the wireless communications network to which the UE 102 is connected, such as the first wireless communications network 140 or the second wireless communications network, occurs, depending on different aspects related to the wireless communications network, the UE 102 may decide to trigger a UE assistance information report or trigger to send an activation request, discussed below, for one or more elements provided in the UE assistance information.

The at least one condition may comprise a channel condition. For example, the channel conditions for one of the wireless communications networks, e.g., the first wireless communications network 140, may have become worse while the channel conditions were improved for another wireless communications network, e.g., the second wireless communications network; thus, the UE 102 may report to the first wireless communications network 140 a preference for a reduced configuration while the UE 102 may report to the second wireless communications network a preference for a configuration that provides improved conditions for communications between the UE 102 and the second wireless communications network, e.g., higher bandwidth, more component carriers, etc.

The at least one condition may comprise a change of data demands in at least one of the first and second wireless communications networks. For example, while there may be a low data demand for one of the wireless communications networks, e.g., the first wireless communications network 140, the UE 102 may report to the first wireless communications network 140 a preference for a reduced configuration, while the UE 102 may report to the second wireless communications network a preference for a configuration that provides improved conditions for communications between the UE 102 and the second wireless communications network, e.g., higher bandwidth, more component carriers, etc.

The first request to the first network node 104 may be provided in response to an expiration of a timer that determines when the UE 102 can send requests to the first and/or second network nodes. For example, the timer may be a timer to prohibit frequent reports sent by the UE 102, such that the UE 102 can only send another report, such as a UE assistance information, or a trigger once the timer expires. The timer may operate with any suitable frequency, and the timer may be adjustable. Once a UE assistance information or a trigger indication is set, the timer may be reset.

The first request to the first network node 104 may be provided in response to one or more out of:
availability of information to be sent in the first request that is different from information previously sent in a prior request to the first network node 104 concerning a reduced set of capabilities;
an occurrence of an event;
an occurrence of network configured conditions;
a handover of the UE 102 from a source cell to a target cell;
a reconfiguration procedure other than a handover;
a connection setup;
a re-establishment procedure;
a resume procedure; and
an indication that the UE is to be suspended.

The first request may be provided based on the availability of information to be sent in the first request that is different from information previously sent in a prior request to the first network node 104 concerning a reduced set of capabilities. Providing different information may be a condition to send a subsequent report, i.e. if the UE 102 has already sent a report concerning reduced UE configuration for Multi-USIM purposes, the UE 102 may only send another report if such report concerns different information compared to the previous report. The report may be a UE assistance information and/or a trigger indication.

The first request may be provided based on an occurrence of an event, or a cause value. For example, the UE 102 may send a report concerning a reduced UE configuration for Multi-USIM purposes if the report is triggered by a certain event or cause, such as e.g. low battery, a certain traffic level, etc.

The first request may be provided during a handover of the UE 102 from a source cell to a target cell. For example, the first request may be provided right after the handover (reconfiguration with sync) to the target cell. The UE 102 may indicate preference for a reduced UE configuration for Multi-USIM purposes to the target cell.

The first request to the first network node 104 may be provided in response to sending a UE assistance information message that no longer includes an indication of UE preference for a certain reduced UE configuration/capabilities for MUSIM purposes.

The first request to the first network node 104 may be provided when the UE 102 initiates an RRC connection reestablishment procedure or when the UE 102 initiates a RRC resume procedure. The configuration related with assistance information on reduced UE configuration for Multi-USIM purposes may be released by the UE 102.

The first request to the first network node 104 may be provided if UE assistance information is sent that no longer includes an indication of UE preference for a certain reduced UE configuration/capabilities for Multi-USIM purposes. For example, if the UE 102 has sent a UE assistance information to a network node with an indication of UE preference to have reduced multiple input multiple output (MIMO) layers, the transmission of a new UE assistance information message where this indication, of UE preference to have reduced MIMO layers, is not present corresponds to no longer having a preference on reduced MIMO layers.

The UE assistance information may be provided to the UE 102 in the first request, or as the first request.

The UE assistance information may be provided to the first network node 104 before triggering the first request to the first network node 104. In other words, the UE assistance information, related to reduced capabilities of the UE 102 for MUSIM purposes, may be sent by the UE 102 to the first network node 104 in advance. In such embodiments, the UE assistance information, which may be stored in the first network node 104, may be activated using a trigger indication, also referred to herein as an activation request, such as, e.g., a lower-layer trigger indication, which the UE 102 may send to the first network node 104. Thus, the UE assistance information related to the set of capabilities may be stored in the first network node 104, and triggering the first request comprises sending a lower-layer trigger indication to the first network node 104 to activate the UE assistance information to disable the set of capabilities. In such embodiments, the first request may comprise the trigger indication, such as a lower-layer trigger indication.

The lower-layer trigger indication may comprise a medium access control (MAC) control element (CE) trigger indication or an uplink control information (UCI) trigger indication. In some embodiments, one or both the MAC CE trigger indication and an UCI trigger indication may be a single bit or a bitmap.

The UE assistance information may include one or more carrier frequencies, e.g., a list of carrier frequencies and/or carrier frequency combinations, that are not to be used as compared to carrier frequencies in the one or more capabilities of the UE 102 provided to the first network node 104. For example, if the UE 102 indicates carriers f2, f3, f4, and f5 as potentially affected carriers to the first wireless communications network 140, a configuration may include 4 entries. A corresponding field is also defined for MAC CE or UCI, i.e., 4 bits may be reserved to indicate those carriers, so the first bit corresponds to f2, the second bit corresponds to f3, the third bit corresponds to f4, and the fourth bit corresponds to f5. Thus, if some services in the second wireless communications network require the use of f4, a MAC CE or UCI may be sent to the first network node 104 (and thus to the first wireless communications network 140), where the third bit corresponding to carrier f4 is set to 1 or to another suitable value. In this way, the UE 102 informs the first network node 104 that the first network node 104 should not configure f4 for communications between the UE 102 and the first network node 104.

The UE 102 may receive an RRC reconfiguration for full capabilities from the first network node 104. Some parts of the full capabilities may be subject to upgraded/downgraded UE configuration and are indicated as such, e.g., configuration for carriers f2, f3, f4, and f5 or MIMO layers. The configurations are further provided with an indication whether these are to be immediately applied or not. If the configuration is not to be immediately applied, the UE 102 only the information on the RRC reconfiguration and waits for a trigger indication, such as, e.g., a lower layer indication, to apply the RRC reconfiguration, where the configurations for f2, f3, f4, and f5 are then applied.

When the first network node 104 receives the UE assistance information from the UE 102 that f4 is the affected carrier, plus the lower-layer trigger indication, the first network node 104 may send a MAC CE or downlink control information (DCI) with the 3rd bit corresponding to f4 set to 1 or another suitable value, such that the UE 102 will deconfigure and no longer use that carrier.

When the first network node 104 uses DCI for indicating UE (re)configuration, a new field may be introduced to refer to indexes in the MUSIM related RRC Reconfiguration message. As an example, a new MAC CE or DCI where the 3rd bit is set back to 0, after the 3rd bit was set to 1, indicates that the UE 102 can revert the deconfiguration, i.e., the UE 102 uses an upgraded RRC configuration.

Action 208. The UE 102 may receive a reconfiguration message. The UE 102 may receive an RRC reconfiguration message and/or a lower-layer indication from the first network node 104 when the first network node 104 accepts the first request and disables the set of capabilities.

Action 210. The UE 102 may receive a rate adaptation instruction. The UE 102 may receive the rate adaptation instruction from the first network node 104 when the first network node 104 accepts the first request and disables the set of capabilities. The rate adaptation instruction may comprise a recommendation for the UE 102 to temporarily reduce a bitrate in one or both an uplink and downlink.

Action 212. The UE 102 may trigger adaptation or downgrading of ongoing services to a lower service quality when the first network node 104 accepts the first request and disables the set of capabilities.

Action 214. The UE 102 may connect to the second network node 106 and use the set of capabilities for a service once the first network node 104 accepts the first request and disables the set of capabilities, such that the UE 102 is connected to the first network node 104 with reduced capabilities without the set of capabilities, and the UE 102 is connected to the second network node 106 using the set of capabilities, for example, reduced capabilities comprising the set of capabilities.

Once the first network node 104 accepts the first request and disables the set of capabilities which are reduced capabilities as compared to the capabilities in the first information sent to the first network node 104, the UE 102 may be configured with the reduced capabilities. The UE 102 may use certain capabilities, which are released for use in connecting to the second network node 106, to connect to the second network node 106. Thus, at this point, the UE 102 is connected to both the first and second wireless communications networks, such that the UE 102 now is in RRC_CONNECTED mode in both first and second networks. The service(s) between the UE 102 and the first network node 104 continue with the reduced capabilities, and the UE 102 uses one or more services at the second network node 106. When the UE is connected to both the wireless communications networks, the used capabilities may be reduced in both wireless communications networks.

After some times has passed, the one or more services between the UE 102 and the second network node 106 may end, such that the UE 102 disconnects from the second network node 106. Thus, the UE 102 may be in the RRC_CONNECTED mode in the first wireless communications network 140, and the UE 102 may be in the RRC_IDLE mode or the RRC_INACTIVE mode in the second wireless communications network.

Furthermore, in some embodiments, rather than disconnecting from the second network node 106 and going into an RRC_INACTIVE mode in the second wireless communications network, it may be desirable not to remove the second network node 106. Instead, a semi/sleeping dual connectivity (DC) may be created, so that, when the UE 102 connects to the second network node 106 again later, the UE 102 can avoid the procedure to setup the network node. In this way, latency may be reduced. As another variation, the UE 102 may instruct the second network node 106 to deactivate the second network node 106, e.g., a secondary cell group (SCG) and enters a semi-RRC_INACTIVE mode.

Action 216. The UE 102 may trigger a second request to the first wireless communications network 140 to reenable the set of capabilities or a portion thereof. In some embodiments, when the UE 102 disconnects from the second network node 106 and continues to be connected to the first network node 104 using the reduced capabilities, the UE 102 triggers the second request to the first network node 104 to reenable at least a portion of the set of capabilities for communication with the first network node 104. It should be noted that, throughout this disclosure, a description of reenabling the set of capabilities comprises reenabling at least a portion of the set of capabilities.

The second request may comprise a UE assistance information, which may be similar to the UE assistance information discussed above in connection with the first request. The second request may comprise a UE assistance information, such that the UE 102 provides the UE assistance information to the second network node 106.

The UE assistance information may comprise one or more of: an indication in an IDC assistance information, an indication in the IDC assistance information in combination with a multiple SIM, MUSIM, indication, and MUSIM assistance information.

The UE assistance information may be provided to the second network node 106 in advance and it may be stored in the second network node 106. The UE assistance information may then be activated, e.g., in response to a trigger indication. In such embodiments, the second request may comprise the trigger indication, such as a lower-layer trigger indication.

Action 218. The UE 102 may receive a reconfiguration message, such as e.g., a second reconfiguration message. The UE 102 may receive an RRC reconfiguration message and/or a lower-layer indication from the first network node 104 when the first network node 104 accepts the second request and reenables at least a portion of the set of capabilities. The lower-layer indication may comprise a MAC CE indication or a DCI/uplink control information (UCI) indication.

Action 220. The UE 102 may receive a second rate adaptation instruction. The UE 102 may receive the second rate adaptation instruction from the first network node 104 when the first network node 104 accepts the second request and reenables at least a portion of the set of capabilities. In some embodiments, the second rate adaptation instruction may comprise a recommendation for the UE 102 to increase the bitrate in one or both an uplink and downlink.

Action 222. The UE 102 may trigger adaptation or upgrading of ongoing services to a higher service quality when the first network node 104 accepts the second request.

Action 224. The UE 102 may further revert to using at least a portion of the (reenabled) set of capabilities of the one or more first capabilities from the first information to connect to the first network node 104 once the first network node 104 accepts the second request and reenables the at least a portion of the set of capabilities.

When the first network node 104 accepts the second request, the first network node 104 may reenable the entire set of the previously disabled capabilities, or it may reenable a portion, or subset, of the previously disabled capabilities.

A dynamic activation/deactivation of connection of the UE 102 to one or both the first and second wireless communications networks may be performed, in order to achieve a desired utilization of the network resource which can be enhanced to support the dynamic update due to, e.g., the UE notification in MAC layer.

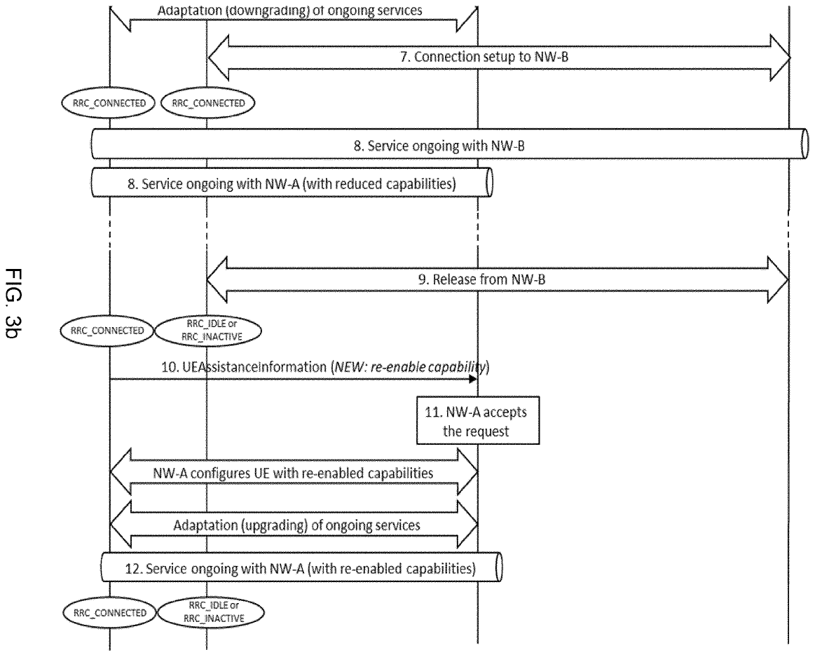

FIG. 3 illustrates a signalling scheme showing communications between the UE 102 and first and second network nodes, in accordance with some reference methods.

For illustration purposes only, first and second network nodes, e.g., first and second network nodes 104 and 106, are associated with network A and network B, respectively, and the method is described with reference to networks A and B. In the example illustrated, network A and network B may be referred as two networks, where a Multi-USIM UE is simultaneously in RRC_CONNECTED. It should be appreciated however that the communications as shown in FIG. 3, and as described elsewhere herein, are also applicable to a case where the UE is connected to more than two wireless communications networks. A person skilled in the art will appreciate how the methods in accordance with embodiments of the present disclosure may be performed in scenarios with more than two wireless communications networks.

As shown in FIG. 3, the UE, such as the UE 102, may have multiple USIMs. In some embodiments, the different USIMs are associated with different wireless communications networks, where a wireless communications network may be a PLMN or a non-public network (NPN). Furthermore, in some embodiments, a UE has more than one USIM which is associated with the same wireless communications network, e.g. a UE has two SIMs from the same operator. In the example of FIG. 3, multiple SIMs, such as USIM1 and USIM2 are associated with different wireless communications networks, but the methods in accordance with embodiments of the present disclosure may also be applied to implementations where multiple USIMs are associated with the same wireless communications network.

The numbered exemplary actions shown in FIG. 3 are described below:
1. The UE 102 registers to Network A (“Registration (UecapA uploaded)”).
   a. UE 102 uploads UE capabilities relevant for Network A (UecapA) to Network A.
   b. Network A configures UE 102 according to the provided UE capabilities.
2. The UE 102 registers to Network B (“Registration (UecapB uploaded)”).
   a. UE 102 upload UE capabilities relevant for Network B (UecapB) to Network B.
   b. Network B configures UE 102 according to the provided UE capabilities.

The UE 102 is registered in the two Networks and the relevant UE capabilities have been provided.

It should be appreciated that the act (2) can be performed before the act (1).

Before a connection setup begins, the UE 102 is in the RRC_IDLE or RRC_INACTIVE state in Network A and Network B.
3. The UE 102 may start service(s) in Network A.
   a. The UE 102 is in RRC_CONNECTED mode only in Network A (and the UE 102 is in RRC_IDLE/RRC_INACTIVE state in Network B).

It should be appreciated that the act (3) can be performed before the act (2).

There is an ongoing service with Network A, as shown in FIG. 3.

After some time passes, the UE 102 may need to connect to Network B.
4. The UE 102 may connect to Network B.
5. The UE 102 sends a request comprising, in this example, UE assistance information (“UEAssistanceInformation (NEW: reduce capability)”) to Network A, requesting that certain capabilities are (temporarily) disabled.
6. Network A may accept the request and disables (possibly temporarily) certain capabilities.
   a. Network A can use RRC Reconfiguration procedure or lower layer means, e.g., MAC CE/DCI indication, to configure the UE 102 with reduced capabilities (“NW-A configures UE with reduced capabilities”).
   b. Network A or the UE 102 may trigger adaptation (downgrading) for ongoing services in Network A (“Adaptation (downgrading) of ongoing services”).
7. The UE 102 may use certain capabilities to connect to Network B (“Connection setup to NW-B”).
   a. The UE 102 now is in RRC_CONNECTED mode in both networks.
8. Service(s) between UE 102 and Network A may continue with reduced capabilities (“Service ongoing with NW-B” and “Service ongoing with NW-A (with reduced capabilities)”).

After some time passes, the service(s) between the UE 102 and Network B may end.
9. Services between the UE 102 and Network B may be ended, and UE 102 disconnects from Network B (“Release from NW-B”).
   a. The UE 102 is now in RRC_CONNECTED mode in Network A and in RRC_IDLE or RRC_INACTIVE in Network B.
10. The UE 102 may further send UE assistance information to Network A requesting that the certain capabilities are reenabled (“UEAssistanceInformation (NEW: re-enable capability)”).
11. Network A may accept the UE request and reenables the previously disabled capabilities or may reenable a subset, e.g., at least a portion, of those capabilities.
   a. Network A can use RRC Reconfiguration or lower layer means, e.g., MAC CE/DCI indication, to reconfigure the UE 102 with re-enabled capabilities “NW-A configures UE with re-enabled capabilities”.
   b. Network A or the UE 102 may trigger adaptation (upgrade) for ongoing services in Network A (“Adaptation (upgrading) of ongoing services”).
12. The UE 102 and Network A may then continue using full capabilities (“Service ongoing with NW-A (with re-enabled capabilities)”).

The UE 102 is in RRC_CONNECTED mode in Network A and in RRC_IDLE or RRC_INACTIVE in Network B.

The procedure in FIG. 3 describes the case when the UE 102 stays in RRC_CONNECTED mode in Network A the entire time and may connect to Network B for a short time. It should be appreciated that the same or similar procedure applies in the case that the UE starts in RRC_CONNECTED mode in Network B and then connects to Network A. It should also be obvious that the same procedure applies for a UE that is in RRC_CONNECTED mode in both wireless communications networks and then leave Network A instead of leaving Network B.

Embodiments of the present disclosure describe when and/or under what condition(s) a wireless communications device, such as the UE 102, will or will not trigger the procedure(s) to indicate the preference of reenabling the capability from both SIMs to one SIM. For example, a MUSIM UE may indicate the preference of reenabling the UE capability from both USIMs to one USIM. That is, embodiments of the present disclosure further describe when and/or under what conditions action 216 is performed. In the following the expressions wireless communications device and UE will be used interchangeably

In embodiments herein, the wireless communications device 102 manages the capability of indicating the preference on temporary capability with the possibility of releasing the capability and reenabling the capability. Reenabling the capability is based on the wireless communications device 102 managing the procedure to reenable the capability, by either triggering the procedure or not triggering the procedure based on different parameters satisfying different conditions. In embodiments herein the word capability may be used interchangeably with the expression UE capability.

In some embodiments herein releasing the UE capability refers to releasing the UE capability supporting NR SA or NR DC from the first wireless communications network 140 to shared UE capability with a first UL for the first wireless communications network 140 and a second UL for the second wireless communications network 160, and the reenabling the UE capability refers to reenabling the UE capability from the shared UE capability to the first wireless communications network 140.

In one set of the embodiments, the UE 102 is capable of NR SA with CA or NR DC on the first wireless communications network 140 before releasing the capability from the first wireless communications network 140 to a shared UE capability between the first and the second wireless communications network 160. To exploit this capability the UE 102 may comprise a first UL transceiver, including UL Tx antenna and data channel chain, for the first wireless communications network 140 and a second UL transceiver for the second wireless communications network 160. In these embodiments the UE 102 may not be capable of NR SA with CA or NR DC on the second wireless communications network 160.

In another set of the embodiments, releasing the UE capability from the first wireless communications network 140 is equivalent to releasing the NR SA with CA or NR DC capability for the first wireless communications network 140.

The solutions below describe a UE using Dual Connectivity in one network. However, the solutions are equally applicable for UEs using Carrier Aggregation. The solutions are also equally applicable for UEs using DC or CA in two or more networks when the UE has more than 2 transmitters and/or receivers.

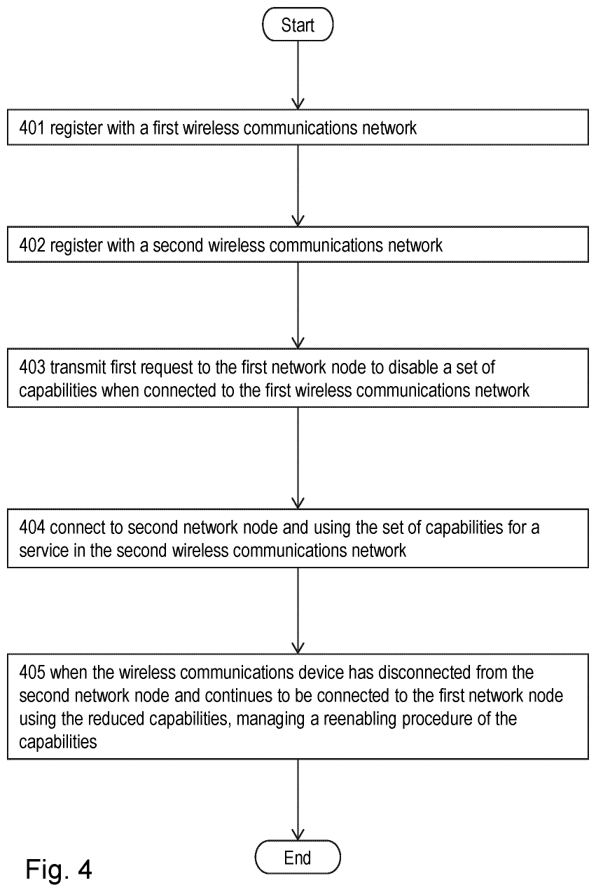

FIG. 4 illustrates a method performed by a wireless communications device, such as the multi-SIM enabled UE 102, for handling communication with two or more wireless communications networks according to embodiments disclosed herein. The wireless communications device 102 comprises at least two SIMs and at least two independent receiver chains and at least two independent transmitter chains. In some embodiments, the wireless communications device 102 has more than two SIMs, e.g., three, four, five, six, or more than six SIMs.

In the following description, when the wireless communications device 102 is connected to the first network and disconnected from the second network, the wireless communications device 102 may be in an RRC_CONNECTED mode in the first network and in an RRC_IDLE mode or an RRC_INACTIVE mode in the second network. When the wireless communications device 102 is connected to the first network and to the second network, the wireless communications device 102 may be in an RRC_CONNECTED mode in the first and second networks.

The method actions may be performed in any suitable order, for example in another order than listed below.

Action 401. The wireless communications device 102 registers with a first wireless communications network 140 associated with a first SIM of the wireless communications device 102, by providing, to a first network node 104 associated with the first wireless communications network 140, one or more first capabilities of the wireless communications device 102 associated with the at least two independent receiver chains and the at least two independent transmitter chains.

Action 402. The wireless communications device 102 registers with a second wireless communications network associated with a second SIM of the wireless communications device 102, by providing, to a second network node 106 associated with the second wireless communications network, one or more second capabilities of the wireless communications device 102 associated with the at least two independent receiver chains and the at least two independent transmitter chains.

Action 403. Upon being connected to the first wireless communications network 140 and using the one or more first capabilities for a service, the wireless communications device 102 transmits a first request to the first network node 104 to disable a set of capabilities from the one or more first capabilities provided to the first network node 104. In embodiments herein disabling the set of capabilities is equivalent to releasing the capabilities.

In some embodiments, releasing the capability of the wireless communications device 102 from the first wireless communications network 140 is equivalent to releasing the NR SA with CA or NR DC capability for the first wireless communications network 140.

In some embodiments, releasing the UE capability from the first wireless communications network 140 is equivalent to restricting the UE capability on the first wireless communications network 140 from having the NR SA (with CA) or NR DC capability to not capable of NR SA (with CA) or NR DC and sharing the UE capability to a second wireless communications network 160. Sharing the UE capability to the second wireless communications network 160 may mean that this UE capability is enabled for the second wireless communications network 160.

Action 404. The wireless communications device 102 connects to the second network node 106 and uses the set of capabilities for a service in the second wireless communications network once the first network node 104 accepts the first request and disables the set of capabilities, such that the wireless communications device 102 is connected to the first network node 104 with reduced capabilities without the set of capabilities, and the wireless communications device 102 is connected to the second network node 106 using the set of capabilities.

Action 405. When the wireless communications device 102 has disconnected from the second network node 106 and continues to be connected to the first network node 104 using the reduced capabilities, the wireless communications device 102 manages a reenabling procedure of the capabilities by: triggering a second request to the first network node 104 to reenable the set of capabilities for communication with the first network node 104 based on whether or not a first a first condition for triggering the re-enablement is fulfilled, or not triggering the second request to the first network node 104 to reenable the set of capabilities for communication with the first network node 104 based on whether or not a second condition for not triggering the re-enablement is fulfilled.

In some embodiments triggering the second request to the first network node 104 is based on whether or not a first property of the wireless communications device 102 or of the first wireless communications network 140 or of the second wireless communications network 160 fulfills the first condition.

Further not triggering the second request may be based on whether or not a second property of the wireless communications device 102 or of the first wireless communications network 140 or of the second wireless communications network 160 fulfills the second condition.

The first and second properties may each relate to a parameter or a state or a status of the first wireless communications network 140 or of the second wireless communications network 160. For example, triggering the second request to the first network node 104 to reenable the set of capabilities for communication with the first network node 104 may be based on whether or not a first parameter fulfills the first condition for triggering the re-enablement. Not triggering the second request to the first network node 104 to reenable the set of capabilities for communication with the first network node 104 may be based on whether or not a second parameter fulfills the second condition for not triggering the re-enablement. The second parameter may differ from the first parameter.

In some embodiments the wireless communications device 121 manages the reenabling procedure of the capabilities by triggering the second request further based on whether or not the second condition for not triggering the re-enablement is fulfilled.

For example, the wireless communications device 121 may manage the reenabling procedure of the capabilities by triggering the second request based on: the first condition for triggering the re-enablement being fulfilled and the second condition for not triggering the re-enablement not being fulfilled. In other words, in some embodiments the wireless communications device 102 is only triggering the reenabling capability procedure if the conditions of triggering the procedure are fulfilled and the conditions of not triggering the procedure are not fulfilled.

In some embodiments herein managing the reenabling procedure of the capabilities by triggering the second request may be based on: the first property or parameter fulfilling the first condition for triggering the re-enablement and the second property or parameter not fulfilling the second condition for not triggering the re-enablement. For example, if there is a high data demand from the first wireless communications network 140, e.g. meaning that it requires to use both receiver chains and/or both transmitter chains, e.g., to apply NR DC to achieve the high throughput, and fulfills the condition to trigger reenabling a capability of NR DC to the first wireless communications network 140, and at the same time none of the conditions for not triggering the reenabling of the capability of NR DC to the first wireless communications network 140 is fulfilled, the result as a combination of the two may be to trigger reenabling the capability of NR DC.

In some embodiments herein managing the reenabling procedure of the capabilities by not triggering the second request is further based on whether or not the first condition for triggering the re-enablement is fulfilled.

For example, managing the reenabling procedure of the capabilities by not triggering the second request may be further based on whether or not the first property or parameter fulfills the first condition for triggering the re-enablement.

In some other embodiments managing the reenabling procedure of the capabilities by not triggering the second request is based on: the first condition for triggering the re-enablement not being fulfilled and the second condition for not triggering the re-enablement being fulfilled. For example, managing the reenabling procedure of the capabilities by not triggering the second request may be based on: the first property or parameter not fulfilling the first condition for triggering the re-enablement and the second property or parameter fulfilling the second condition for not triggering the re-enablement.

In some other embodiments managing the reenabling procedure of the capabilities by not triggering the second request is based on: the first condition for triggering the re-enablement being fulfilled and the second condition for not triggering the re-enablement being fulfilled. For example, managing the reenabling procedure of the capabilities by not triggering the second request may be based on: the first property or parameter fulfilling the first condition for triggering the re-enablement and the second property or parameter fulfilling the second condition for not triggering the re-enablement. In other words, in some embodiments the wireless communications device 102 is not triggering the reenabling capability procedure if the conditions of triggering the procedure and the conditions of not triggering the procedure are both fulfilled. For example, if there is a high data demand from the first wireless communications network 140 which requires to apply NR DC to achieve high throughput and based on the high data demand the condition to trigger the reenabling of the capability of NR DC to the first wireless communications network 140 is fulfilled, but at the same time one of the conditions for not triggering the reenabling of the capability to the first wireless communications network 140 is valid, then the result as a combination of the two conditions may be to not trigger reenabling the capability.

In some other embodiments managing the reenabling procedure of the capabilities by not triggering the second request is based on: the first condition for triggering the re-enablement not being fulfilled and the second condition for not triggering the re-enablement not being fulfilled. For example, managing the reenabling procedure of the capabilities by not triggering the second request is based on: the first property or parameter not fulfilling the first condition for triggering the re-enablement and the second property or parameter not fulfilling the second condition for not triggering the re-enablement.

As mentioned above, the first condition may be related to the first property or the first parameter. The second condition may be related to the second property or the second parameter. The below disclosure will provide for detailed examples of the first and second conditions and first and second properties or parameters.

The first condition to trigger the procedure may based on one or more of:
a. a data demand from the wireless communications device 102 to the first wireless communications network 140;
b. a user preference of one of the first wireless communications network 140 and the second wireless communications network 160;
c. a service type of the first wireless communications network 140;
d. an emergency condition for the first wireless communications network 140. For example, If there is an emergency then the first condition to trigger may be fulfilled. The wireless communications device 102 may obtain an indicator of the emergency, for example from the first wireless communications network 140
e. a parameter configuring IDLE or INACTIVE mode operation of the second wireless communications network 160;
f. a mobility pattern or a velocity of the wireless communications device 102; and
g. No scheduled UL transmission in the second wireless communications network 160.

The first condition may be based on several of the above properties a) to g), e.g. on several first sub conditions. Such sub conditions may be combined with some weights to the first sub conditions. For example, if more first conditions are fulfilled then there may be a higher chance to trigger the request for reenabling the capabilities. In some embodiments the first condition is fulfilled if all first sub conditions are fulfilled. In some embodiments the first condition is fulfilled if more than a certain number of first sub conditions are fulfilled.

### Data Demand

In some embodiments, the wireless communications device 102 has a high data demand for the first wireless communications network 140. For example, the wireless communications device 102 requires a high amount of data downloading which requires NR DC to reach a higher throughput. This may then trigger the reenabling procedure. For example if the data demand from the wireless communications device 102 to the first wireless communications network 140 is above a data demand threshold then the wireless communications device 102 may trigger the reenabling procedure.

### User Preference

In some embodiments, the wireless communications device 102 triggers the reenabling procedure based on the user's selection of a primary USIM, i.e., a most prioritized USIM. Thus, the wireless communications device 102 may obtain a prioritization of the two wireless communications networks 140, 160, e.g., from a user.

One benefit of this is that the network of the user's preferred USIM may be more optimized for better performance.

In one set of embodiments, the wireless communications device 102 triggers the reenabling procedure based on user's selection of the preferred operator of the region/area. One benefit of this is that the network of the user's preferred operator may be more optimized for better performance.

In one set of embodiments, the wireless communications device 102 triggers the reenabling procedure based on a user's software or application or tool, such as user's interface type of software or application, which makes a list of the USIMs with different priorities. One benefit is that it provides more flexibility to the users where it may optimize the USIM usage based on the current network status.

In one set of embodiments, the wireless communications device 102 triggers the reenabling procedure based on an indication of a USIM being for a primary wireless communications network or a secondary wireless communications network, e.g., depending on a physical placement of the USIM in the terminal or whether the user has selected one wireless communications network as the primary wireless communications network (or preferred wireless communications network or prioritized wireless communications network). The secondary wireless communications network may be of a lower prioritization than the primary wireless communications network. The user indication may be automatic, for example a company USIM may be regarded as primary during working hours while a private USIM may be regarded as primary outside working hours, by users' preference. A switching between which USIM is primary, and which is secondary, may be done automatically based on, e.g., time of day, weekday or weekend/holiday, geographical location, etc., by users' preference.

In one set of embodiments, the wireless communications device 102 triggers the reenabling procedure based on a priority list of wireless communications networks. One benefit is that the network of the higher priority may be more optimized for better performance.

### Service Type of the Wireless Communications Networks

In one set of embodiments the wireless communications device 102 triggers the reenabling procedure for the first wireless communications network 140 if it has a higher priority of a service, such as an Ultra Reliable Low Latency Communication (URLLC) service.

Different wireless communications networks may have different requirements coupled to different services. For example, RedCap UE is a lower version of NR UE which supports most of the NR features but with lower requirements, for example, the RedCap UE may support fewer Rx chains than the maximum number of supported Rx chains. One example is at certain bands the full NR UE may support 4 Rx antenna ports with 4 layers MIMO as the maximum capability, but a RedCap UE may only support 2 Rx antenna ports with 2 layers MIMO, at the same bands. Hence, the maximum throughput for the RedCap UE is highly reduced, compared to the full NR capability UE. Depending on the different UE types with different maximum throughputs to be achieved, different wireless communication networks may provide different type of services. In one set of embodiments, the wireless communications device 102 selects the wireless communications network which has higher requirements for one or more of fast connection setup, or higher throughput, or higher retainability, etc. One benefit is that the network with the service type with higher priority or higher requirements may be more optimized for better performance.

### Emergency Condition for the First Wireless Communications Network

In one set of embodiments, the wireless communications device 102 triggers the reenabling procedure based on an emergency call or a nature disaster indication. One benefit of this is that the first wireless communications network 140 may stay more robust for the wireless communications device 102 and avoid losing connection for such emergency cases.

### Parameters Configuring Idle or Inactive Mode Operation of the Second Wireless Communications Network

In one set of embodiments, the wireless communications device 102 triggers the reenabling procedure based on a configuration of a RAN notification area. A larger area means lower chance to trigger RAN-based Notification Area Update (RNAU), i.e. lower need for UL in USIM 2. The wireless communications device 102 triggers the procedure for re-enabling its capabilities for a RAN notification area which is larger than a threshold RAN notification area.

For longer measurement period or paging cycle in the second wireless communications network 160, the wireless communications device 102 may more likely trigger the reenabling procedure since it is less likely that it needs to again share the capabilities during a coming time period.

### A Mobility Pattern or a Velocity of the Wireless Communications Device

In one set of embodiments, the wireless communications device 102 triggers the reenabling procedure based on the velocity of the wireless communications device 102. For example, if the velocity of the wireless communications device 102 is lower than a threshold velocity then the wireless communications device 102 may trigger the re-enabling of capabilities. If the velocity is higher than the threshold a risk of releasing the connection to the second wireless communications network 160 or releasing some of the capabilities again are higher. Thus, for a high velocity there is a risk of unnecessary signaling if the reenabling procedure is triggered.

In one set of embodiments, the wireless communications device 102 triggers the reenabling procedure based on a UE mobility pattern. The UE mobility pattern may include a few levels of speeds, e.g., low speed is <5 km/h, medium speed is >=5 km and <70 km/h, high speed is >=70 km/h. In some embodiments triggering the reenabling procedure applies only if the speed of the wireless communications device 102 is within the low speed range.

### No Scheduled Ul Transmission in the Second Wireless Communications Network

In one set of embodiments, the wireless communications device 102 may trigger the reenabling procedure based on that there is no scheduled UL transmission in the second wireless communications network 160. When the wireless communications device 102 knows it expects to transition back to CONNECTED in the second wireless communications network 160, e.g. due to scheduled UL transmission like UL data, the wireless communications device 102 does not trigger the re-enabling of capabilities.

Or, in other words, when the wireless communications device 102 does not expect to transition back to CONNECTED shortly in the second wireless communications network 160 it may trigger the re-enabling of the capabilities.

The second condition to not trigger the procedure may be based on one or more of:
h. a need for updating information from the wireless communications device 102 to the second wireless communications network 160;
i. a state of the wireless communications device 102 or of the first wireless communications network 140 for which it is not possible or not favorable to configure the first wireless communications network 140 with measurement gaps or MUSIM gaps;
j. a parameter configuring IDLE or INACTIVE mode operation of the second wireless communications network 160;
k. a state of the wireless communications device 102 in which the wireless communications device 102 does not operate according to its full capacity; and
l. a channel condition of a channel between the first network node 104 and the wireless communications device 102 measured by the wireless communications device 102.

The second condition may be based on several of the above properties h) to l), e.g. on several second sub conditions. Such sub conditions may be combined with some weights to the second sub conditions. For example, if more second conditions are fulfilled then there may be a higher chance not to trigger the request for reenabling the capabilities. In some embodiments the second condition is fulfilled if all second sub conditions are fulfilled. In some embodiments the second condition is fulfilled if more than a certain number of second sub conditions are fulfilled.

### Need for Updating Information in Second Wireless Communications Network 160

In one set of embodiments, the wireless communications device 102 performs location update or other periodic procedures in the second wireless communications network 160, before triggering reenabling the UE capability to the first wireless communications network 140. That is, the wireless communications device 102 may decide to not trigger the reenabling of the capability to the first wireless communications network 140 if the wireless communications device 102 performs location update or other periodic procedures in the second wireless communications network 160. The benefit is that it provides the possibility to reduce the signaling or procedure of connection and reconnection, and consequently lowers the power consumption of the wireless communications device 102.

Not Possible or Not Favorable to Configure the First Wireless Communications Network with Measurement Gaps or MUSIM Gaps

In one set of embodiments, the wireless communications device 102 doesn't trigger reenabling the capability to the first wireless communications network 140 when the first wireless communications network 140 can't configure a measurement gap. For example, if the first wireless communications network 140 does not support measurement gaps, e.g., for measuring another USIM's paging, the wireless communications device 102 may decide to keep the transceiver in the second wireless communications network 160.

An URLLC service is more sensitive to the gaps, so if the URLLC service is ongoing in the first wireless communications network 140 the wireless communications device 102 may keep the transceiver in the second wireless communications network 160.

If the wireless communications device 102 is in bad coverage in the first wireless communications network 140 there may be a risk that the reconfiguration to setup the gap can cause dropped connection. This may also be one general reason not to trigger the re-enabling of the capabilities.

### Parameter Configuring Idle or Inactive Mode Operation of the Second Wireless Communications Network

In one set of embodiments, the wireless communications device 102 doesn't trigger reenabling UE capability to the first wireless communications network 140 based on an earlier RNA configuration of the second wireless communications network 160. For example, when the wireless communications device 102 is already configured to perform idle measurements on one or more carriers which are not configured for the first wireless communications network 140 the wireless communications device 102 needs to use more resources on the second second wireless communications network 160 despite the fact of being in IDLE/INACTIVE mode.

### The Wireless Communications Device Does Not Operate According to its Full Capacity

In one set of embodiments, the wireless communications device 102 doesn't trigger reenabling UE capability to the first wireless communications network 140 based on limitations of the wireless communications device 102. For example, the wireless communications device 102 may decide to not trigger the reenabling procedure if the remaining power of the wireless communications device 102 is low to avoid draining the wireless communications device 102 of power due to the reenabling procedure.

Such limitations may be related to the battery power of the wireless communications device 102 or to a temperature of the wireless communications device 102. For example, for extreme conditions such as very cold or very warm the wireless communications device 102 may decide to not trigger the reenabling procedure.

### Channel Condition of a Channel Between the First Network Node and the Wireless Communications Device

In one set of embodiments, the wireless communications device 102 doesn't trigger the reenabling procedure based on poor channel conditions detected for the first wireless communications network 140, e.g., through parameters such as Signal to Interference and Noise Ratio (SINR) or Channel Quality Indicator (CQI) or Reference-Signal-Receive-Power (RSRP) or Reference Signal Received Quality (RSRQ).

For example, when the first wireless communications network 140 is in poor channel condition and the wireless communications device 102 reports radio Link Failure the wireless communications device 102 should not try to reenable the UE capability from the second wireless communications network 160 and avoid reconfiguration. One benefit is that the first wireless communications network 140 may stay more robust for the wireless communications device 102 and avoid losing connection.

In one set of the embodiments, the wireless communications device 102 continuously checks if the conditions of triggering the reenabling capability procedure and the conditions of not triggering the procedure are fulfilled or not, until the reenabling procedure is triggered.

In one set of embodiments, reenabling the UE capability to the first wireless communications network 140 from the shared UE capability between the first and the second wireless communications networks comprises removing a restriction of the capability on the first wireless communications network 140. For example, the restriction may be that the wireless communications device 140 is not capable of NR SA with CA or NR DC. Then removing the restriction may comprise regaining the capability of being capable of NR SA with CA or NR DC.

FIG. 5 depicts a flowchart illustrating some embodiments herein. The flowchart describes optional details of action 405 described above. For example, as a part of action 405 the wireless communications device 102 may determine whether one or more first conditions to trigger the reenabling of the UE capability are fulfilled. If the one or more first conditions are fulfilled then the wireless communications device 102 may trigger the reenabling procedure.

As another part of action 405 the wireless communications device 102 may determine whether one or more second conditions not to trigger the reenabling of the UE capability are fulfilled.

The two determining actions may be combined or performed without performing the other action. When combined, these two determining actions may be performed in any order. For example, the wireless communications device 102 may first determine whether or not the one or more first conditions are fulfilled and then determine whether or not the one or more second conditions are fulfilled.

Embodiments herein provides implementation solutions for the wireless communications device 102 to decide under what conditions to trigger the procedure of reenabling the capability from shared capability on both the first and second wireless communications networks 140, 160 to the first wireless communications network 140, and under what conditions not to trigger the procedure of reenabling the capability.

When the wireless communications device 102 decides to trigger the procedure of reenabling the capability, it helps the wireless communications device 102 prioritize the first wireless communications network 140 such that network resources are more optimized based on the prioritization to support the user's needs.

Further, when the wireless communications device 102 decides not to trigger the procedure of reenabling the capability, it provides the possibility to reduce the signaling, and consequently the power consumption of the wireless communications device 102.

FIGS. 6A and 6B depict an example of a wireless communications device, such as the UE 102, in accordance with embodiments herein. The wireless communications device 102 may have at least a first SIM and a second SIM.

The wireless communications device 102 may comprise processing circuitry 511, e.g., one or more processors, configured to perform the methods herein.

The wireless communications device 102 may comprise a registering unit 512. The wireless communications device 102, the processing circuitry 511, and/or the registering unit 512 are configured to register with the first wireless communications network 140 associated with the first SIM, by providing, to the first network node 104 associated with the first wireless communications network 140, the first information comprising the one or more first capabilities of the wireless communications device 102. The wireless communications device 102, the processing circuitry 511, and/or the registering unit 512 are also configured to register, with the second wireless communications network associated with the second SIM, by providing, to the second network node 106 associated with the second wireless communications network, the second information on comprising the one or more second capabilities of the wireless communications device 102.

The one or more first capabilities of the wireless communications device 102 in the first information comprise UE capabilities relevant to the first wireless communications network 140. In some embodiments, the first information comprises information on full capabilities of the wireless communications device 102.

The wireless communications device 102, the processing circuitry 511, and/or the registering unit 512 may be configured to register with the first wireless communications network 140 such that the wireless communications device 102, the processing circuitry 511, and/or the registering unit 512 are configured by the first network node 104 based on the first information comprising one or more first capabilities of the wireless communications device 102. The first network node 104 may configure the wireless communications device 102 according to the first capabilities of the wireless communications device 102 provided to the first network node 104.

The wireless communications device 102, the processing circuitry 511, and/or the registering unit 512 are configured to register with the second network such that the wireless communications device 102, the processing circuitry 511, and/or the registering unit 512 are configured by the second network node 106 based on the second information comprising one or more second capabilities of the wireless communications device 102.

The second network node 106 may configure the wireless communications device 102 according to the second capabilities of the wireless communications device 102 provided to the second network node 106.

The wireless communications device 102 may comprise a transmitting unit 514 e.g., a transmitter or a transceiver. The wireless communications device 102, the processing circuitry 511, and/or the transmitting unit 514 may be configured to, upon being connected to the first wireless communications network 140 and using the one or more first capabilities from the first information for the service, trigger or provide the first request to the first network node 104 to disable the set of capabilities from the one or more first capabilities in the first information provided to the first network node 104.

The wireless communications device 102, the processing circuitry 511, and/or the transmitting unit 514 may provide the first request that comprises the UE assistance information. The first request, which may comprise the UE assistance information, may be provided in response to occurrence of various events and in various circumstances which are discussed above in connection with FIG. 2 (act 206) and which are discussed elsewhere herein.

In some embodiments, the wireless communications device 102, the processing circuitry 511, and/or the transmitting unit 514 may provide the UE assistance to the first network node 104 before triggering the first request to the first network node 104. Thus, the UE assistance information, related to reduced capabilities of the wireless communications device 102 for MUSIM purposes, may be sent by the wireless communications device 102 to the first network node 104 in advance. In such embodiments, the UE assistance information may be stored in the first network node 104, and the UE assistance information may be activated using the trigger indication, such as, e.g., a lower-layer trigger indication, which the wireless communications device 102 may send to the first network node 104 when the wireless communications device 102 connects to another network node. Thus, in some embodiments, the UE assistance information related to the set of capabilities is stored in the first network node 104, and the wireless communications device 102, the processing circuitry 511, and/or the transmitting unit 514 may trigger the first request by sending a lower-layer trigger indication to the first network node 104 to activate the previously stored UE assistance information to disable the set of capabilities.

The wireless communications device 102, the processing circuitry 511, and/or the transmitting unit 514 may be configured to, when the wireless communications device 102 disconnects from the second network node 106 and continues to be connected to the first network node 104 using the reduced capabilities, trigger or provide the second request to the first network node 104 to reenable the set of capabilities for communication with the first network node 104.

The second request may comprise a UE assistance information. In some embodiments, the UE assistance information comprises one or more of: an indication in an IDC assistance information, an indication in the IDC assistance information in combination with a multiple SIM, MUSIM, indication, and MUSIM assistance information.

In some embodiments, the wireless communications device 102, the processing circuitry 511, and/or the transmitting unit 514 may be configured to provide the UE assistance information to the second network node 106 in advance, such that the UE assistance information may be stored in the second network node 106. The wireless communications device 102, the processing circuitry 511, and/or the transmitting unit 514 may be configured to then activate the UE assistance information, e.g., in response to a trigger indication. The second request may thus comprise the trigger indication, such as a lower-layer trigger indication.

In some embodiments, the wireless communications device 102, the processing circuitry 511, and/or the transmitting unit 514 may be configured to trigger adaptation or downgrading of ongoing services to a lower service quality when the first network node 104 accepts the first request and disables the set of capabilities.

In some embodiments, the wireless communications device 102, the processing circuitry 511, and/or the transmitting unit 514 may be configured to trigger adaptation or upgrading of ongoing services to a higher service quality when the first network node 104 accepts the second request.

The wireless communications device 102 may comprise a connecting unit 516, e.g., a transmitter or a transceiver. The wireless communications device 102, the processing circuitry 511, and/or the connecting unit 516 may be configured to connect and disconnect from a network node, such as the first network node 104, the second network node 106, and/or any other network node associated with a wireless communications network that is associated with a SIM in the wireless communications device 102.

In some embodiments, the wireless communications device 102, the processing circuitry 511, and/or the connecting unit 516 may be configured to connect to the first network node 104.

In some embodiments, the wireless communications device 102, the processing circuitry 511, and/or the connecting unit 516 may be configured to connect to the second network node 106 and use the set of capabilities for a service once the first network node 104 accepts the first request and disables the set of capabilities. Thus, the wireless communications device 102 becomes connected to the first network node 104 with reduced capabilities without the set of capabilities, and the wireless communications device 102 connects to the second network node 106 using reduced capabilities comprising the set of capabilities. Thus, at this point, the wireless communications device 102 is connected to both the first and second networks, such that the wireless communications device 102 now is in RRC_CONNECTED mode in both first and second networks. The service(s) between the wireless communications device 102 and the first network node 104 continue with the reduced capabilities, and the wireless communications device 102 uses one or more services at the second network node 106.

In some embodiments, the wireless communications device 102, the processing circuitry 511, and/or the connecting unit 516 may be configured to revert to using at least a portion of the (reenabled, and previously disabled) set of capabilities of capabilities from the first information, to connect to the first network node 104 once the first network node 104 accepts the second request and reenables the at least a portion of the set of capabilities. Thus, the wireless communications device 102, the processing circuitry 511, and/or the connecting unit 516 may be configured to enable the wireless communications device 102 to connect to the first network node 104 using the set of capabilities, or a portion thereof, which were previously disabled to allow the wireless communications device 102 to connect to the second network node 106.

The wireless communications device 102, the processing circuitry 511, and/or the connecting unit 516 may be configured to receive a (re)configuration instruction from at least one of the first and second network nodes.

The wireless communications device 102 may comprise a reenabling unit 518. The wireless communications device 102, the processing circuitry 511, and/or the reenabling unit 518 may be configured to manage a reenabling procedure of the capabilities by triggering the second request to the first network node 104 to reenable the set of capabilities for communication with the first network node 104 based on whether or not a first a first condition for triggering the re-enablement is fulfilled, or not triggering the second request to the first network node 104 to reenable the set of capabilities for communication with the first network node 104 based on whether or not a second condition for not triggering the re-enablement is fulfilled.

In some embodiments herein the wireless communications device 102 is further configured to manage the reenabling procedure of the capabilities by being configured to trigger the second request further based on whether or not the second condition for not triggering the re-enablement is fulfilled.

The wireless communications device 102 may be further configured to manage the reenabling procedure of the capabilities by being configured to trigger the second request further based on the first condition for triggering the re-enablement being fulfilled and the second condition for not triggering the re-enablement not being fulfilled.

In some embodiments herein the wireless communications device 102 is further configured to manage the reenabling procedure of the capabilities by being configured to not triggering the second request further based on whether or not the first condition for triggering the re-enablement is fulfilled.

The wireless communications device 102 may be further configured to manage the reenabling procedure of the capabilities by being configured to not triggering the second request further based on the first condition for triggering the re-enablement not being fulfilled and the second condition for not triggering the re-enablement being fulfilled.

In some embodiments herein the wireless communications device 102 is further configured to manage the reenabling procedure of the capabilities by being configured to not triggering the second request further based on the first condition for triggering the re-enablement being fulfilled and the second condition for not triggering the re-enablement being fulfilled.

The wireless communications device 102 may be further configured to manage the reenabling procedure of the capabilities by being configured to not triggering the second request further based on the first condition for triggering the re-enablement not being fulfilled and the second condition for not triggering the re-enablement not being fulfilled.

The wireless communications device 102 may be further configured to manage the reenabling procedure based on whether or not the first property fulfills the first condition and based on whether or not the second property fulfills the second condition.

The wireless communications device 102 further comprises a memory 515. The memory 515 comprises one or more units to be used to store data on, such as indications, contexts, measurements, thresholds, data related to nodes, and applications to perform the methods disclosed herein when being executed, and similar. Furthermore, the wireless communications device 102 may comprise a communication interface 520 such as comprising a transmitter, a receiver and/or a transceiver. In embodiments herein, the communication interface 520 may comprise dual Rx and Tx radios, e.g., at least two independent receiver chains and at least two independent transmitter chains. In some embodiments, the communication interface 520 comprises more than two radios.

The methods according to the embodiments described herein for the wireless communications device 102 are respectively implemented using e.g., a computer program product 526 or a computer program, comprising instructions, i.e., software code portions, which, when executed on at least one processor, cause the at least one processor to carry out the actions described herein, as performed by the wireless communications device 102. The computer program product 526 may be stored on a computer-readable storage medium 527, e.g. a disc, a universal serial bus (USB) stick or similar. The computer-readable storage medium 527, having stored thereon the computer program product, may comprise the instructions which, when executed on at least one processor, cause the at least one processor to carry out the actions described herein, as performed by the wireless communications device 102. In some embodiments, the computer-readable storage medium may be a transitory or a non-transitory computer-readable storage medium. Thus, embodiments herein may disclose a wireless communications device for handling communication in a wireless communications network, wherein the wireless communications device comprises processing circuitry and a memory, the memory comprising instructions executable by the processing circuitry whereby the wireless communications device is operative to perform any of the methods herein.

In some embodiments, a more general term “network node” is used and it can correspond to any type of radio-network node or any network node, which communicates with a wireless device and/or with another network node. Examples of network nodes are NodeB, MeNB, SeNB, a network node belonging to Master cell group (MCG) or Secondary cell group (SCG), base station (BS), multi-standard radio (MSR) radio node such as MSR BS, eNodeB, network controller, radio-network controller (RNC), base station controller (BSC), relay, donor node controlling relay, base transceiver station (BTS), access point (AP), transmission points, transmission nodes, Remote radio Unit (RRU), Remote Radio Head (RRH), nodes in distributed antenna system (DAS), etc.

In some embodiments, the non-limiting term wireless device or user equipment (UE) is used and it refers to any type of wireless device communicating with a network node and/or with another wireless device in a cellular or mobile communication system. Examples of UE are IoT capable device, target device, device to device (D2D) UE, proximity capable UE (aka ProSe UE), machine type UE or UE capable of machine to machine (M2M) communication, Tablet, mobile terminals, smart phone, laptop embedded equipped (LEE), laptop mounted equipment (LME), USB dongles, etc.

Embodiments are applicable to any RAT or multi-RAT systems, where the wireless device receives and/or transmit signals (e.g. data) e.g. New Radio (NR), Wi-Fi, Long Term Evolution (LTE), LTE-Advanced, Wideband Code Division Multiple Access (WCDMA), Global System for Mobile communications/enhanced Data rate for GSM Evolution (GSM/EDGE), Worldwide Interoperability for Microwave Access (WiMax), or Ultra Mobile Broadband (UMB), just to mention a few possible implementations.

As will be readily understood by those familiar with communications design, that functions means or circuits may be implemented using digital logic and/or one or more microcontrollers, microprocessors, or other digital hardware. In some embodiments, several or all of the various functions may be implemented together, such as in a single application-specific integrated circuit (ASIC), or in two or more separate devices with appropriate hardware and/or software interfaces between them. Several of the functions may be implemented on a processor shared with other functional components of a wireless device or network node, for example.

Alternatively, several of the functional elements of the processing means discussed may be provided through the use of dedicated hardware, while others are provided with hardware for executing software, in association with the appropriate software or firmware. Thus, the term “processor” or “controller” as used herein does not exclusively refer to hardware capable of executing software and may implicitly include, without limitation, digital signal processor (DSP) hardware and/or program or application data. Other hardware, conventional and/or custom, may also be included. Designers of communications devices will appreciate the cost, performance, and maintenance trade-offs inherent in these design choices.

The present disclosure further comprises embodiments, and any combination of the embodiments, according to any one or more of FIGS. 1A, 1B, 2, 3, 4, 5, 6A and 6B.

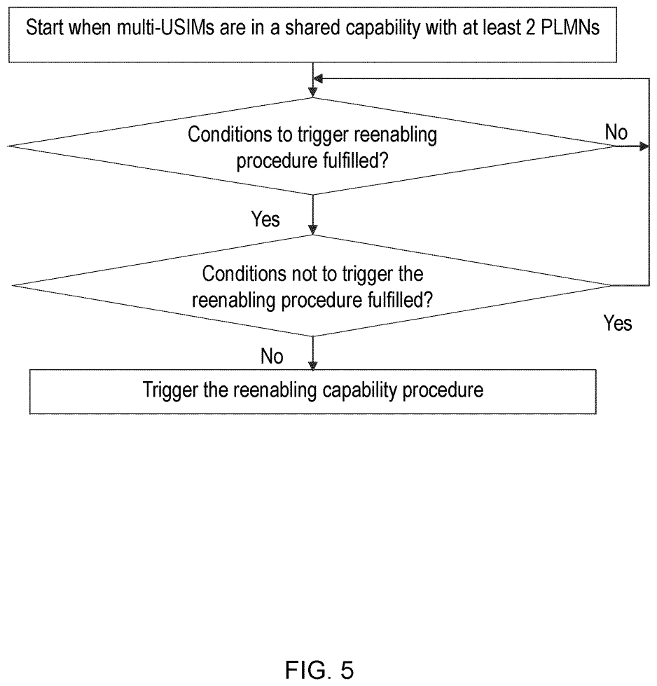

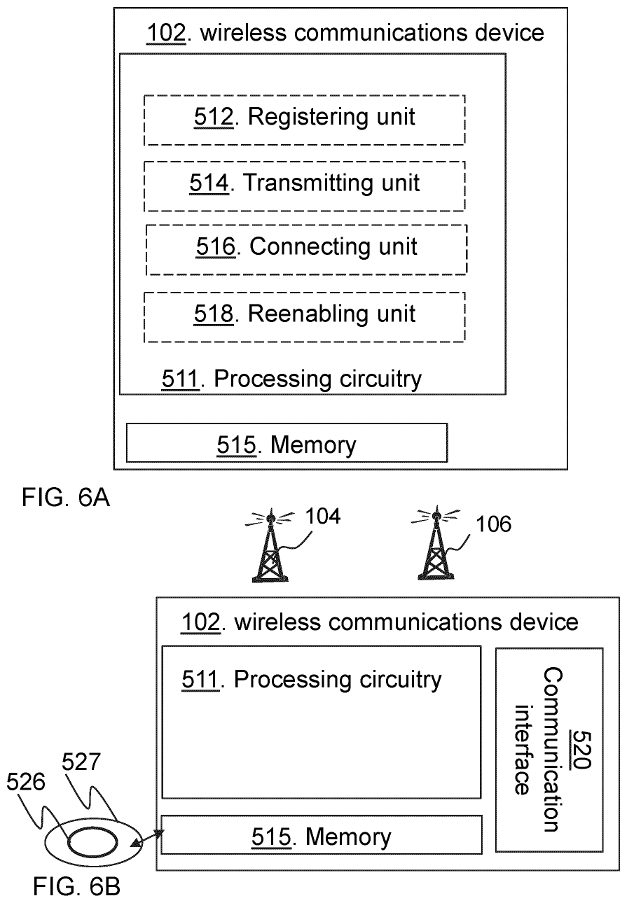

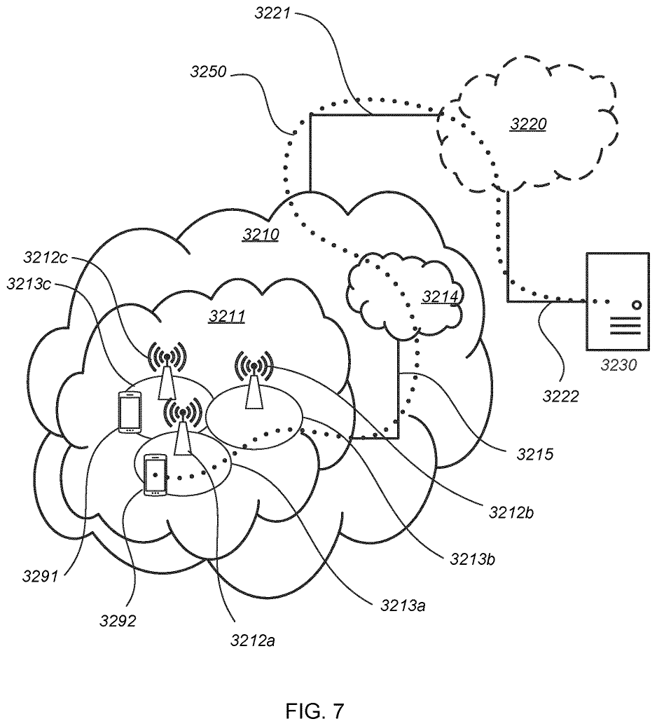

FIG. 7 shows a telecommunication network connected via an intermediate network to a host computer in accordance with some embodiments. With reference to FIG. 7, in accordance with an embodiment, a communication system includes a telecommunication network 3210, such as a 3GPP-type cellular network, which comprises access network 3211, such as a radio access network, and core network 3214. Access network 3211 comprises a plurality of base stations 3212a, 3212b, 3212c, such as NBs, eNBs, gNBs or other types of wireless access points being examples of the network nodes above, each defining a corresponding coverage area 3213a, 3213b, 3213c. Each base station 3212a, 3212b, 3212c is connectable to core network 3214 over a wired or wireless connection 3215. A first UE 3291 located in coverage area 3213c is configured to wirelessly connect to, or be paged by, the corresponding base station 3212c. A second UE 3292 in coverage area 3213a is wirelessly connectable to the corresponding base station 3212a. While a plurality of Ues 3291, 3292 are illustrated in this example being examples of the UE 102 above, the disclosed embodiments are equally applicable to a situation where a sole UE is in the coverage area or where a sole UE is connecting to the corresponding base station 3212.

Telecommunication network 3210 is itself connected to host computer 3230, which may be embodied in the hardware and/or software of a standalone server, a cloud-implemented server, a distributed server or as processing resources in a server farm. Host computer 3230 may be under the ownership or control of a service provider, or may be operated by the service provider or on behalf of the service provider. Connections 3221 and 3222 between telecommunication network 3210 and host computer 3230 may extend directly from core network 3214 to host computer 3230 or may go via an optional intermediate network 3220. Intermediate network 3220 may be one of, or a combination of more than one of, a public, private or hosted network; intermediate network 3220, if any, may be a backbone network or the Internet; in particular, intermediate network 3220 may comprise two or more sub-networks (not shown).

The communication system of FIG. 7 as a whole enables connectivity between the connected Ues 3291, 3292 and host computer 3230. The connectivity may be described as an over-the-top (OTT) connection 3250. Host computer 3230 and the connected Ues 3291, 3292 are configured to communicate data and/or signalling via OTT connection 3250, using access network 3211, core network 3214, any intermediate network 3220 and possible further infrastructure (not shown) as intermediaries. OTT connection 3250 may be transparent in the sense that the participating communication devices through which OTT connection 3250 passes are unaware of routing of uplink and downlink communications. For example, base station 3212 may not or need not be informed about the past routing of an incoming downlink communication with data originating from host computer 3230 to be forwarded (e.g., handed over) to a connected UE 3291. Similarly, base station 3212 need not be aware of the future routing of an outgoing uplink communication originating from the UE 3291 towards the host computer 3230.

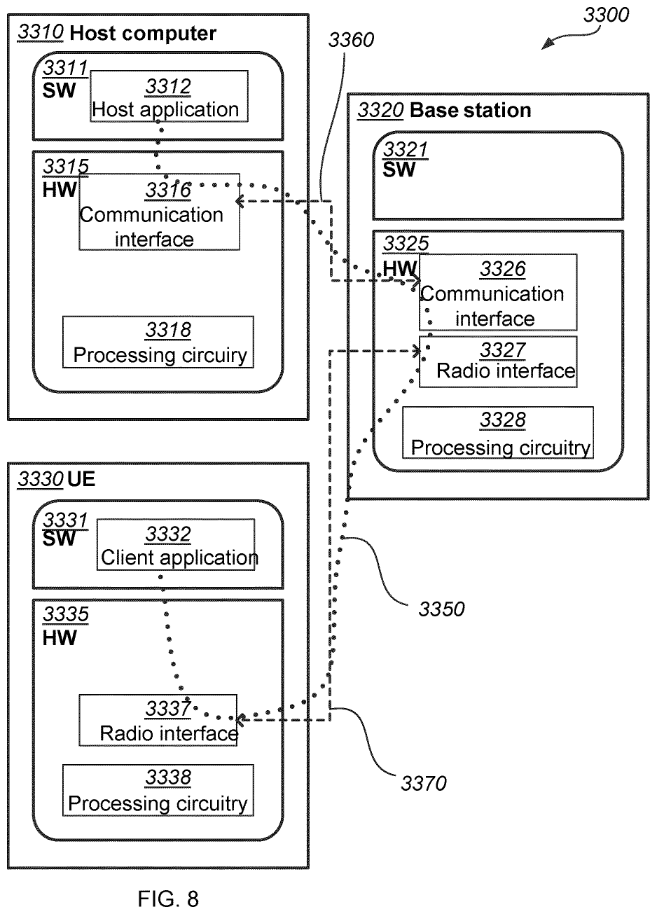

FIG. 8 shows a host computer communicating via a base station and with a user equipment over a partially wireless connection in accordance with some embodiments

Example implementations, in accordance with an embodiment, of the UE, base station and host computer discussed in the preceding paragraphs will now be described with reference to FIG. 8. In communication system 3300, host computer 3310 comprises hardware 3315 including communication interface 3316 configured to set up and maintain a wired or wireless connection with an interface of a different communication device of communication system 3300. Host computer 3310 further comprises processing circuitry 3318, which may have storage and/or processing capabilities. In particular, processing circuitry 3318 may comprise one or more programmable processors, application-specific integrated circuits, field programmable gate arrays or combinations of these (not shown) adapted to execute instructions. Host computer 3310 further comprises software 3311, which is stored in or accessible by host computer 3310 and executable by processing circuitry 3318. Software 3311 includes host application 3312. Host application 3312 may be operable to provide a service to a remote user, such as UE 3330 connecting via OTT connection 3350 terminating at UE 3330 and host computer 3310. In providing the service to the remote user, host application 3312 may provide user data which is transmitted using OTT connection 3350.

Communication system 3300 further includes base station 3320 provided in a telecommunication system and comprising hardware 3325 enabling it to communicate with host computer 3310 and with UE 3330. Hardware 3325 may include communication interface 3326 for setting up and maintaining a wired or wireless connection with an interface of a different communication device of communication system 3300, as well as radio interface 3327 for setting up and maintaining at least wireless connection 3370 with UE 3330 located in a coverage area (not shown in FIG. 8) served by base station 3320. Communication interface 3326 may be configured to facilitate connection 3360 to host computer 3310. Connection 3360 may be direct or it may pass through a core network (not shown in FIG. 8) of the telecommunication system and/or through one or more intermediate networks outside the telecommunication system. In the embodiment shown, hardware 3325 of base station 3320 further includes processing circuitry 3328, which may comprise one or more programmable processors, application-specific integrated circuits, field programmable gate arrays or combinations of these (not shown) adapted to execute instructions. Base station 3320 further has software 3321 stored internally or accessible via an external connection.

Communication system 3300 further includes UE 3330 already referred to. It's hardware 3333 may include radio interface 3337 configured to set up and maintain wireless connection 3370 with a base station serving a coverage area in which UE 3330 is currently located. Hardware 3333 of UE 3330 further includes processing circuitry 3338, which may comprise one or more programmable processors, application-specific integrated circuits, field programmable gate arrays or combinations of these (not shown) adapted to execute instructions. UE 3330 further comprises software 3331, which is stored in or accessible by UE 3330 and executable by processing circuitry 3338. Software 3331 includes client application 3332. Client application 3332 may be operable to provide a service to a human or non-human user via UE 3330, with the support of host computer 3310. In host computer 3310, an executing host application 3312 may communicate with the executing client application 3332 via OTT connection 3350 terminating at UE 3330 and host computer 3310. In providing the service to the user, client application 3332 may receive request data from host application 3312 and provide user data in response to the request data. OTT connection 3350 may transfer both the request data and the user data. Client application 3332 may interact with the user to generate the user data that it provides.

It is noted that host computer 3310, base station 3320 and UE 3330 illustrated in FIG. 8 may be similar or identical to host computer 3230, one of base stations 3212a, 3212b, 3212c and one of Ues 3291, 3292 of FIG. 7, respectively. This is to say, the inner workings of these entities may be as shown in FIG. 8 and independently, the surrounding network topology may be that of FIG. 7.

In FIG. 8, OTT connection 3350 has been drawn abstractly to illustrate the communication between host computer 3310 and UE 3330 via base station 3320, without explicit reference to any intermediary devices and the precise routing of messages via these devices. Network infrastructure may determine the routing, which it may be configured to hide from UE 3330 or from the service provider operating host computer 3310, or both. While OTT connection 3350 is active, the network infrastructure may further take decisions by which it dynamically changes the routing (e.g., on the basis of load balancing consideration or reconfiguration of the network).

Wireless connection 3370 between UE 3330 and base station 3320 is in accordance with the teachings of the embodiments described throughout this disclosure. One or more of the various embodiments improve the performance of OTT services provided to UE 3330 using OTT connection 3350, in which wireless connection 3370 forms the last segment. More precisely, the teachings of these embodiments make it possible communicate using a UE with multiple SIMs in an efficient manner. Thereby the communication may be performed in an efficient manner resulting in better responsiveness.

A measurement procedure may be provided for the purpose of monitoring data rate, latency and other factors on which the one or more embodiments improve. There may further be an optional network functionality for reconfiguring OTT connection 3350 between host computer 3310 and UE 3330, in response to variations in the measurement results. The measurement procedure and/or the network functionality for reconfiguring OTT connection 3350 may be implemented in software 3311 and hardware 3315 of host computer 3310 or in software 3331 and hardware 3333 of UE 3330, or both. In embodiments, sensors (not shown) may be deployed in or in association with communication devices through which OTT connection 3350 passes; the sensors may participate in the measurement procedure by supplying values of the monitored quantities exemplified above, or supplying values of other physical quantities from which software 3311, 3331 may compute or estimate the monitored quantities. The reconfiguring of OTT connection 3350 may include message format, retransmission settings, preferred routing etc. ; the reconfiguring need not affect base station 3320, and it may be unknown or imperceptible to base station 3320. Such procedures and functionalities may be known and practiced in the art. In certain embodiments, measurements may involve proprietary UE signalling facilitating host computer 3310's measurements of throughput, propagation times, latency and the like. The measurements may be implemented in that software 3311 and 3331 causes messages to be transmitted, in particular empty or ‘dummy’ messages, using OTT connection 3350 while it monitors propagation times, errors, etc.

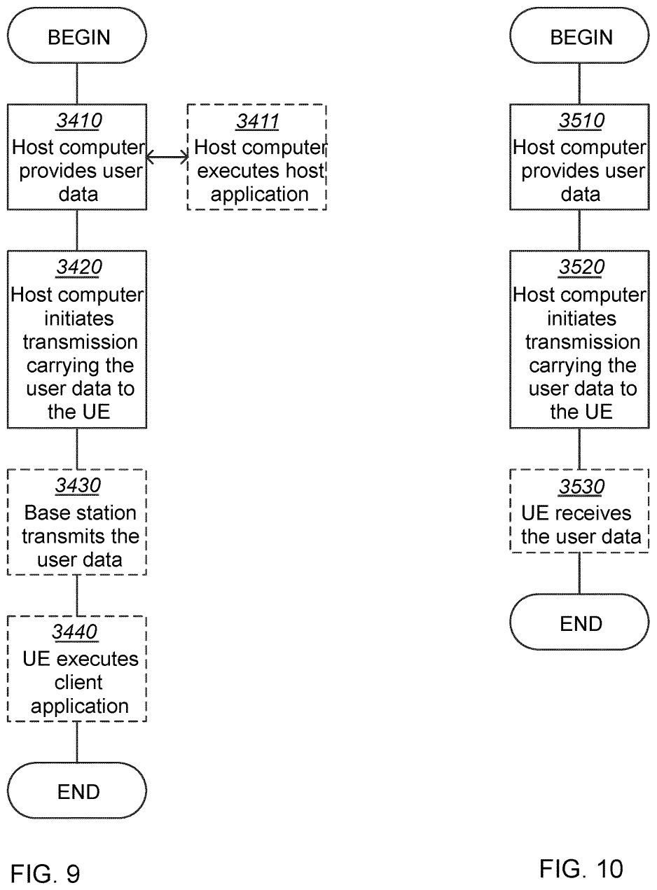

FIG. 9 shows methods implemented in a communication system including a host computer, a base station and a user equipment in accordance with some embodiments.

FIG. 9 is a flowchart illustrating a method implemented in a communication system, in accordance with one embodiment. The communication system includes a host computer, a base station and a UE which may be those described with reference to FIG. 7 and FIG. 8. For simplicity of the present disclosure, only drawing references to FIG. 9 will be included in this section. In step 3410, the host computer provides user data. In substep 3411 (which may be optional) of step 3410, the host computer provides the user data by executing a host application. In step 3420, the host computer initiates a transmission carrying the user data to the UE. In step 3430 (which may be optional), the base station transmits to the UE the user data which was carried in the transmission that the host computer initiated, in accordance with the teachings of the embodiments described throughout this disclosure. In step 3440 (which may also be optional), the UE executes a client application associated with the host application executed by the host computer.

FIG. 10 shows methods implemented in a communication system including a host computer, a base station and a user equipment in accordance with some embodiments.

FIG. 10 is a flowchart illustrating a method implemented in a communication system, in accordance with one embodiment. The communication system includes a host computer, a base station and a UE which may be those described with reference to FIGS. 7 and 8. For simplicity of the present disclosure, only drawing references to FIG. 10 will be included in this section. In step 3510 of the method, the host computer provides user data. In an optional substep (not shown) the host computer provides the user data by executing a host application. In step 3520, the host computer initiates a transmission carrying the user data to the UE. The transmission may pass via the base station, in accordance with the teachings of the embodiments described throughout this disclosure. In step 3530 (which may be optional), the UE receives the user data carried in the transmission.

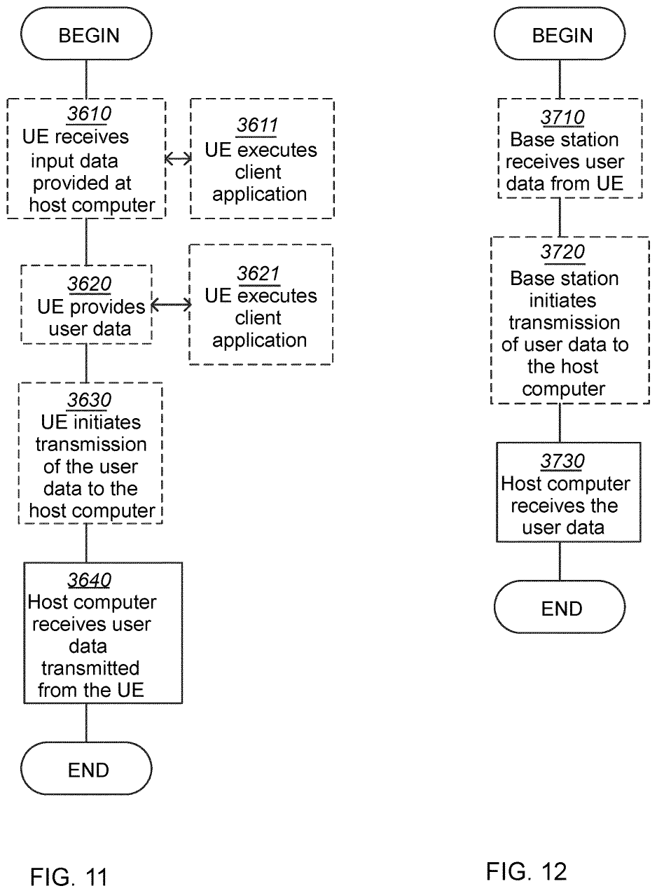

FIG. 11 shows methods implemented in a communication system including a host computer, a base station and a user equipment in accordance with some embodiments.

FIG. 11 is a flowchart illustrating a method implemented in a communication system, in accordance with one embodiment. The communication system includes a host computer, a base station and a UE which may be those described with reference to FIGS. 7 and 8. For simplicity of the present disclosure, only drawing references to FIG. 11 will be included in this section. In step 3610 (which may be optional), the UE receives input data provided by the host computer. Additionally or alternatively, in step 3620, the UE provides user data. In substep 3621 (which may be optional) of step 3620, the UE provides the user data by executing a client application. In substep 3611 (which may be optional) of step 3610, the UE executes a client application which provides the user data in reaction to the received input data provided by the host computer. In providing the user data, the executed client application may further consider user input received from the user. Regardless of the specific manner in which the user data was provided, the UE initiates, in substep 3630 (which may be optional), transmission of the user data to the host computer. In step 3640 of the method, the host computer receives the user data transmitted from the UE, in accordance with the teachings of the embodiments described throughout this disclosure.

FIG. 12 shows methods implemented in a communication system including a host computer, a base station and a user equipment in accordance with some embodiments.

FIG. 12 is a flowchart illustrating a method implemented in a communication system, in accordance with one embodiment. The communication system includes a host computer, a base station and a UE which may be those described with reference to FIG. 7 and FIG. 8. For simplicity of the present disclosure, only drawing references to FIG. 12 will be included in this section. In step 3710 (which may be optional), in accordance with the teachings of the embodiments described throughout this disclosure, the base station receives user data from the UE. In step 3720 (which may be optional), the base station initiates transmission of the received user data to the host computer. In step 3730 (which may be optional), the host computer receives the user data carried in the transmission initiated by the base station.

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include digital signal processors (DSPs), special-purpose digital logic, and the like. The processing circuitry may be configured to execute program code stored in memory, which may include one or several types of memory such as read-only memory (ROM), random-access memory (RAM), cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according one or more embodiments of the present disclosure.

It will be appreciated that the foregoing description and the accompanying drawings represent non-limiting examples of the methods and apparatus taught herein. As such, the apparatus and techniques taught herein are not limited by the foregoing description and accompanying drawings. Instead, the embodiments herein are limited only by the following claims and their legal equivalents.

1-15. (canceled)

16. A method, performed by a wireless communications device comprising at least two Subscriber Identity Modules (SIMs) and at least two independent receiver chains and at least two independent transmitter chains, for handling communication with two or more wireless communications networks, the method comprising:
registering with a first wireless communications network associated with a first SIM of the wireless communications device by providing, to a first network node associated with the first wireless communications network, one or more first capabilities of the wireless communications device associated with the at least two independent receiver chains and the at least two independent transmitter chains;
registering with a second wireless communications network associated with a second SIM of the wireless communications device by providing, to a second network node associated with the second wireless communications network, one or more second capabilities of the wireless communications device associated with the at least two independent receiver chains and the at least two independent transmitter chains;
upon being connected to the first wireless communications network and using the one or more first capabilities for a service, transmitting a first request to the first network node to disable a set of capabilities from the one or more first capabilities provided to the first network node;
connecting to the second network node and using the set of capabilities for a service in the second wireless communications network once the first network node accepts the first request and disables the set of capabilities, such that the wireless communications device is connected to the first network node with reduced capabilities without the set of capabilities, and the wireless communications device is connected to the second network node using the set of capabilities; and
when the wireless communications device has disconnected from the second network node and continues to be connected to the first network node using the reduced capabilities, managing a re-enabling procedure of the capabilities by:
triggering a second request to the first network node to re-enable the set of capabilities for communication with the first network node based on whether a first a first condition for triggering the re-enablement is fulfilled, or
not triggering the second request to the first network node to re-enable the set of capabilities for communication with the first network node based on whether a second condition for not triggering the re-enablement is fulfilled.

17. The method of claim 16, wherein managing the re-enabling procedure of the capabilities by triggering the second request is further based on whether the second condition for not triggering the re-enablement is fulfilled.

18. The method of claim 17, wherein managing the re-enabling procedure of the capabilities by triggering the second request is based on: the first condition for triggering the re-enablement being fulfilled and the second condition for not triggering the re-enablement not being fulfilled.

19. The method of claim 16, wherein managing the re-enabling procedure of the capabilities by not triggering the second request is further based on whether the first condition for triggering the re-enablement is fulfilled.

20. The method of claim 19, wherein managing the re-enabling procedure of the capabilities by not triggering the second request is based on: the first condition for triggering the re-enablement not being fulfilled and the second condition for not triggering the re-enablement being fulfilled.

21. The method of claim 19, wherein managing the re-enabling procedure of the capabilities by not triggering the second request is based on: the first condition for triggering the re-enablement being fulfilled and the second condition for not triggering the re-enablement being fulfilled.

22. The method of claim 19, wherein managing the re-enabling procedure of the capabilities by not triggering the second request is based on: the first condition for triggering the re-enablement not being fulfilled and the second condition for not triggering the re-enablement not being fulfilled.

23. The method of claim 16, wherein triggering the second request to the first network node is based on whether a first property of the wireless communications device or of the first wireless communications network or of the second wireless communications network fulfills the first condition and wherein not triggering the second request is based on whether a second property of the wireless communications device or of the first wireless communications network or of the second wireless communications network fulfills the second condition.

24. The method of claim 16, wherein the first condition to trigger the procedure is based on one or more of:
a data demand from the wireless communications device to the first wireless communications network;
a user preference of one of the first wireless communications network and the second wireless communications network;
a service type of the first wireless communications network;
an emergency condition for the first wireless communications network;
a parameter configuring IDLE or INACTIVE mode operation of the second wireless communications network;
a mobility pattern or a velocity of the wireless communications device; and
no scheduled Uplink (UL) transmission in the second wireless communications network.

25. The method of claim 16, wherein the second condition to not trigger the procedure is based on one or more of:
a need for updating information from the wireless communications device to the second wireless communications network;
a state of the wireless communications device or of the first wireless communications network for which it is not possible or not favorable to configure the first wireless communications network with measurement gaps or Multi Universal SIM (MUSIM) gaps;
a parameter configuring IDLE or INACTIVE mode operation of the second wireless communications network;
a state of the wireless communications device in which the wireless communications device does not operate according to its full capacity; and
a channel condition of a channel between the first network node and the wireless communications device measured by the wireless communications device.

26. The method of claim 16, wherein when the wireless communications device is connected to the first wireless communications network and disconnected from the second wireless communications network, the wireless communications device is in an RRC_CONNECTED mode in the first wireless communications network and in an RRC_IDLE mode or an RRC_INACTIVE mode in the second wireless communications network; and/or when the wireless communications device is connected to the first wireless communications network and to the second wireless communications network, the wireless communications device is in an RRC_CONNECTED mode in the first and second wireless communications networks.

27. A non-transitory computer-readable medium comprising, stored thereupon, a computer program, comprising computer readable code units configured so as to, when executed on a wireless communications device, cause the wireless communications device to perform the method of claim 16.

28. A wireless communications device comprising at least two Subscriber Identity Modules (SIMs) and at least two independent receiver chains and at least two independent transmitter chains, configured for handling communication with two or more wireless communications networks, the wireless communications device being further configured to:
register with a first wireless communications network associated with a first SIM of the wireless communications device, by providing, to a first network node associated with the first wireless communications network, one or more first capabilities of the wireless communications device associated with the at least two independent receiver chains and the at least two independent transmitter chains;
register with a second wireless communications network associated with a second SIM of the wireless communications device, by providing, to a second network node associated with the second wireless communications network, one or more second capabilities of the wireless communications device associated with the at least two independent receiver chains and the at least two independent transmitter chains;
upon being connected to the first wireless communications network and using the one or more first capabilities for a service, transmit a first request to the first network node to disable a set of capabilities from the one or more first capabilities provided to the first network node;
connect to the second network node and using the set of capabilities for a service in the second wireless communications network once the first network node accepts the first request and disables the set of capabilities, such that the wireless communications device is connected to the first network node with reduced capabilities without the set of capabilities, and the wireless communications device is connected to the second network node using the set of capabilities; and
when the wireless communications device has disconnected from the second network node and continues to be connected to the first network node using the reduced capabilities, manage a re-enabling procedure of the capabilities by being configured to: trigger a second request to the first network node to re-enable the set of capabilities for communication with the first network node based on whether a first a first condition for triggering the re-enablement is fulfilled, or
not trigger the second request to the first network node to re-enable the set of capabilities for communication with the first network node based on whether a second condition for not triggering the re-enablement is fulfilled.

29. The wireless communications device of claim 28, wherein the triggering of the second request to the first network node is based on whether a first property of the wireless communications device or of the first wireless communications network or of the second wireless communications network fulfills the first condition and wherein the not triggering of the second request is based on whether a second property of the wireless communications device or of the first wireless communications network or of the second wireless communications network fulfills the second condition.

30. The wireless communications device of claim 28, wherein the first condition to trigger the procedure is based on one or more of:
a data demand from the wireless communications device to the first wireless communications network;
a user preference of one of the first wireless communications network and the second wireless communications network;
a service type of the first wireless communications network;
an emergency condition for the first wireless communications network;
a parameter configuring IDLE or INACTIVE mode operation of the second wireless communications network;
a mobility pattern or a velocity of the wireless communications device; and
no scheduled Uplink (UL) transmission in the second wireless communications network.

31. The wireless communications device of claim 28, wherein the second condition to not trigger the procedure is based on one or more of:
a need for updating information from the wireless communications device to the second wireless communications network;
a state of the wireless communications device or of the first wireless communications network for which it is not possible or not favorable to configure the first wireless communications network with measurement gaps or Multi Universal SIM (MUSIM) gaps;
a parameter configuring IDLE or INACTIVE mode operation of the second wireless communications network;
a state of the wireless communications device in which the wireless communications device does not operate according to its full capacity; and
a channel condition of a channel between the first network node and the wireless communications device measured by the wireless communications device.

32. The wireless communications device of claim 28, wherein the wireless device is configured so that when the wireless communications device is connected to the first wireless communications network and disconnected from the second wireless communications network, the wireless communications device is in an RRC_CONNECTED mode in the first wireless communications network and in an RRC_IDLE mode or an RRC_INACTIVE mode in the second wireless communications network; and/or when the wireless communications device is connected to the first wireless communications network and to the second wireless communications network, the wireless communications device is in an RRC_CONNECTED mode in the first and second wireless communications networks.
